(19) United States
(12) Patent Application Publication
(10) Pub. No.: US 2018/0165618 A1
(43) Pub. Date: Jun. 14, 2018

(54) RESOURCE SCHEDULING FOR FIELD SERVICES

(71) Applicant: Microsoft Technology Licensing, LLC, Redmond, WA (US)

(72) Inventors: Ishai Menache, Redmond, WA (US); Mohit Singh, Bellevue, WA (US); Bishara Kharoufeh, Sammamish, WA (US); Chris Mossell, Snoqualmie, WA (US); Janeth Guerrero Gomez, Duvall, WA (US); Konstantina Mellou, Cambridge, MA (US); Kyle S. Young, Duvall, WA (US)

(21) Appl. No.: 15/379,279

(22) Filed: Dec. 14, 2016

(51) Int. Cl. G06Q 10/06

(52) U.S. Cl. CPC G06Q 10/06313; G06Q 10/06311

(57) ABSTRACT

Schedules are generated that satisfy the objectives of a field services provider given a set of resources and a set of work orders. More particularly, work orders are identified, as well as the identity of resources that are capable with fulfilling one or more of the work orders, are obtained. Feasible paths are established for each resource that identify a sequence of one or more work orders that can be fulfilled by the resource over the course of the resource's work shift and which reflect one or more scheduling objectives. These feasible paths are established in a series of iterations, with each iteration identifying additional paths. After each iteration, it is determined if a pre-selected time limit has been exceeded, and whenever the time limit has been exceeded, path generation ceases. Schedules are established for the resources using the generated paths and are then provided to the field service provider.

### BACKGROUND

In many types of businesses, companies operate by deploying a set of resources that are used to fulfill customer requests (often referred to as work orders) at the customer's location. A resource can be a human that fulfills work orders. For example, a resource might be a technician such as an electrician, plumber, carpenter, handyman, pest control service provider, or the like that are associated with the home maintenance industry. A salesman is another example of a human resource that visits customers in order to offer the company's services.

A resource can also be a non-human asset that is needed to fulfill a work order. For example, a resource can be an animal such as a search and rescue dog, or a detection dog that sniffs out explosives or drugs. A resource can also be a specialized piece of equipment or specialized vehicle that is needed to fulfill a work order.

When the number of resources and work orders is large, the procedure of generating schedules for the daily trips of the resources can become very challenging.

### SUMMARY

The field services resource scheduling implementations described herein generally involve a resource scheduler that generates resource schedules which satisfy the objectives of a field services provider given a set of resources and a set of work orders. More particularly, the resource scheduler receives the identity of work orders associated with the field services, as well as the identity of resources that are capable with fulfilling one or more of the work orders during the course of a resource work shift. The work orders are assigned attributes identifying where and when a work order is to be fulfilled. In one implementation this includes a physical location where the work order is to be fulfilled, a duration time indicating how long it will take to fulfill the work order, and a time window indicating a period of time in which the work order can be fulfilled. In one implementation, a resource is compatible with fulfilling a work order if the resource can travel to the work order location from a current location after a start time of the resource's work shift, arrive within the time window associated with the work order, fulfill the work order within the duration time associated with the work order, and still reach an end location by the end of the resource's work shift.

The resource scheduler then establishes schedules for each resource which identify a sequence of one or more work orders that can be fulfilled by the resource over the course of the resource's work shift and which reflects one or more prescribed scheduling objectives. The schedules established for the resources are established in a series of iterations with each iteration identifying paths for at least one or more of the resources. After each iteration, it is determined if a pre-selected time limit has been exceeded, and whenever the time limit has been exceeded, the resource scheduler ceases identifying paths and establishes schedules from the identified paths.

The schedules established for each resource are then provided to a field service provider associated with the resources and work orders. In one implementation, prior to providing the schedules established for each resource, the resource scheduler selects one of the schedules established for each resource as the schedule for the resource's shift. In this implementation, the selected schedule established for each resource is provided to the field service provider.

In one implementation, the resource scheduler includes one or more computing devices. These computing devices are in communication with each other via a computer network whenever there is a plurality of computing devices. In addition, the resource scheduler includes a computer program having a plurality of sub-programs executed by the computing devices to perform the foregoing actions. In another implementation, the resource scheduler includes a field service provider computing device and a resource scheduler computer program having a plurality of sub-programs executed by the computing device to perform the foregoing actions.

It should be noted that the foregoing Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter. Its sole purpose is to present some concepts of the claimed subject matter in a simplified form as a prelude to the more-detailed description that is presented below.

### DESCRIPTION OF THE DRAWINGS

The specific features, aspects, and advantages of the field services resource scheduling implementations described herein will become better understood with regard to the following description, appended claims, and accompanying drawings where:

FIG. 1 is a diagram illustrating one implementation of a decomposition process showing resources and work orders as nodes.

FIG. 2 is a diagram illustrating one implementation of the decomposition process of FIG. 1, showing a selected resource and the work orders the resource can visit.

FIG. 3 is a diagram illustrating one implementation of the decomposition process of FIG. 2, showing, for each work order visited by the resource of FIG. 2, the other resources that could fulfill these work orders as well.

FIG. 4 is a diagram illustrating one implementation of the decomposition process of FIG. 3, showing another resource from the active resources being selected and the work orders it can visit.

FIG. 5 is a diagram illustrating one implementation of the decomposition process of FIG. 4, showing, for each work order that was just visited, that no other resources could fulfill these work orders.

FIG. 6 is a diagram illustrating one implementation of the decomposition process of FIG. 5, showing, that the last active resource cannot visit any work orders that have not already been visited.

FIG. 7 is a diagram illustrating a simplified implementation of a tree data structure where all paths start from the starting location s of the resource and end with the visit of the current main work order w. In order to build the tree, given the path of a node, an attempt is made to add new work orders before the main work order w where each new path that is created corresponds to a child of a node in the tree. The bolded characters in FIG. 7 show the new work order that was added to the path of the parent when the child was created.

FIG. 8 is a diagram illustrating two trees of sub-paths where Tree 1 includes sub-paths that start from the starting location of the resource and end with the visit of the main work order, and Tree 2 includes the sub-paths that start from the main work order and go to an ending location.

FIG. 9 is a diagram illustrating the merging of the trees of FIG. 8 by trying to combine the root of Tree 1 with the root of Tree 2.

FIG. 10 is a diagram illustrating the merging of the trees of FIG. 8 by trying to combine the first node of Tree 1 with the child nodes of Tree 2.

FIG. 11 is a diagram illustrating the merging of the trees of FIG. 8 by trying to combine the first node of Tree 2 with the child nodes of Tree 1.

FIG. 12 is a diagram illustrating one implementation, in simplified form, of a system framework for realizing the field service resource scheduling implementations described herein.

FIG. 13 is a diagram illustrating another implementation, in simplified form, of a system framework for realizing the field service resource scheduling implementations described herein.

FIG. 14 is a diagram of an overview of the various constituents used by the resource scheduler service and resource scheduler to establish schedules.

FIGS. 15A-B present a flow diagram illustrating an exemplary implementation, in simplified form, of sub-program actions for establishing schedules for each resource where an initial schedule is established for a resource in the first schedule establishing iteration.

FIG. 16 is a flow diagram illustrating an exemplary implementation, in simplified form, of sub-program actions for generating additional feasible paths in subsequent schedule establishing iterations.

FIG. 17 is a flow diagram illustrating an exemplary implementation, in simplified form, of sub-program actions for determining if an iteration stop criterion has been met and ceasing the generation of additional paths, which takes into consideration the number of additional paths generated

FIG. 18 is a flow diagram illustrating an exemplary implementation, in simplified form, of sub-program actions for employing a path weight to determine whether a generated path is to be eliminated.

FIG. 19 is a flow diagram illustrating an exemplary implementation, in simplified form, of sub-program actions for determining if an iteration stop criterion has been met and ceasing the generation of additional paths, which takes into consideration whether a prescribed number of candidate paths have been generated that have path weights that exceed the resource threshold established for a resource.

FIG. 20 is a flow diagram illustrating an exemplary implementation, in simplified form, of sub-program actions for determining if an iteration stop criterion has been met and ceasing the generation of additional paths, which takes into consideration whether a prescribed number of additional paths have been generated that have path weights that do not exceed the resource threshold established for a resource.

FIG. 21 is a flow diagram illustrating an exemplary implementation, in simplified form, of sub-program actions for determining if an iteration stop criterion has been met and ceasing the generation of additional paths, which takes into consideration the sum of the weights of the remaining work orders.

FIG. 22 is a flow diagram illustrating an exemplary implementation, in simplified form, of sub-program actions for selecting one of the initial paths generated for a resource as the schedule for the resource's shift.

FIG. 23 is a flow diagram illustrating an exemplary implementation, in simplified form, of sub-program actions for selecting one of the paths generated for a resource as the schedule for the resource's shift where the iteration procedure is stopped in a subsequent schedule establishing iteration.

FIG. 24 is a flow diagram illustrating an exemplary implementation, in simplified form, of a process for scheduling resources for field services.

FIG. 25 is a diagram illustrating a simplified example of a general-purpose computer system on which various implementations and elements of field services resource scheduling, as described herein, may be realized.

### DETAILED DESCRIPTION

In the following description of field service resource scheduling (or resource scheduling for short) implementations reference is made to the accompanying drawings which form a part hereof, and in which are shown, by way of illustration, specific implementations in which resource scheduling can be practiced. It is understood that other implementations can be utilized and structural changes can be made without departing from the scope of the resource scheduling implementations.

It is also noted that for the sake of clarity specific terminology will be resorted to in describing the resource scheduling implementations described herein and it is not intended for these implementations to be limited to the specific terms so chosen. Furthermore, it is to be understood that each specific term includes all its technical equivalents that operate in a broadly similar manner to achieve a similar purpose. Reference herein to “one implementation”, or “another implementation”, or an “exemplary implementation”, or an “alternate implementation”, or “one version”, or “another version”, or an “exemplary version”, or an “alternate version”, or “one variant”, or “another variant”, or an “exemplary variant”, or an “alternate variant” means that a particular feature, a particular structure, or particular characteristics described in connection with the implementation/version/variant can be included in at least one implementation of resource scheduling. The appearances of the phrases “in one implementation”, “in another implementation”, “in an exemplary implementation”, “in an alternate implementation”, “in one version”, “in another version”, “in an exemplary version”, “in an alternate version”, “in one variant”, “in another variant”, “in an exemplary variant”, and “in an alternate variant” in various places in the specification are not necessarily all referring to the same implementation/version/variant, nor are separate or alternative implementations/versions/variants mutually exclusive of other implementations/versions/variants. Yet furthermore, the order of process flow representing one or more implementations, or versions, or variants of resource scheduling does not inherently indicate any particular order nor imply any limitations of the resource scheduling.

As utilized herein, the terms “component,” “system,” “client” and the like are intended to refer to a computer-related entity, either hardware, software (e.g., in execution), firmware, or a combination thereof. For example, a component can be a process running on a processor, an object, an executable, a program, a function, a library, a subroutine, a computer, or a combination of software and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, to the extent that the terms “includes,” “including,” “has,” “contains,” variants thereof, and other similar words are used in either this detailed description or the claims, these terms are intended to be inclusive, in a manner similar to the term “comprising”, as an open transition word without precluding any additional or other elements.

### 1.0 Field Services Resource Scheduling

The field services resource scheduling implementations described herein generally provide schedules that satisfy the objectives of a field services provider given a set of resources and a set of work orders. These implementations are advantageous for various reasons including, but not limited to, the following.

As will be appreciated from the foregoing and the more-detailed description that follows, the resource scheduling implementations are centralized in that resources are not scheduled in isolation of other resources. Rather, a schedule is generated for each resource considering all the resources and all the work orders. Since some work orders can be visited by more than one resource, coordination among resources is advantageous.

The resource scheduling implementations described herein are also advantageous in that many types of compatibility constraints among the resources (such as shift times, territory, and skills/characteristics, and so on) and the work orders they can serve (such as duration and time windows) are taken into account in generating resource schedules.

The resource scheduling implementations described herein are also advantageous in that they satisfy the objectives of a field services provider. For instance, in some cases it is desired to maximize the number of customers that are visited, while in others it is desired to maximize the number of hours the resource is working or minimize the total time it spends traveling between locations. Further, resource schedules can be generated that satisfy multiple objectives at the same time.

The resource scheduling implementations described herein are also advantageous in that they do not necessarily find the optimum schedules for each resource, or all the possible schedules for each resource. Rather, resource scheduling implementations described herein focus on quickly generating feasible schedules that satisfy the objectives of a field services provider. For example, feasible schedules can be generated for the resources until a prescribed time limit is reached, or an acceptable level of precision short of optimal is reached

### 2.0 Resources and Work Orders

In general, given a set of work orders (WO), a set of resources (R) and pairs P⊆WO×R that specify which work order can be done by which resource, the eligible pairs are defined in one implementation by characteristic as well as territory considerations. Each work order w can come with a location loc(w), duration dur(w), time window [st(w), et(w)]. Each resource rϵR can come with a starting location startloc(r), a starting time st(r), an ending location endloc(r) and ending time et(r). Also given are the transit time dt(l, l′) between any two locations l and l′. A solution accepts a subset of work orders W′⊆WO and gives an assignment π: W′→A with the following constraints. First, for each resource r, there exists a path starting from startloc(r) at time st(r) and ending at endloc(r) by ending time et(r) visiting all nodes in π⁻¹(r) in their respective time windows. Moreover, the resource must spend at least dur(w) time at each work order wϵπ⁻¹(a). Secondly, W′ can be maximized. A more detailed description follows.

### 2.1 Resources

Each resource r comes with a set of shifts Sᵣ during which it is available to serve work orders. In one implementation, each shift sϵSᵣ is defined by a starting time st(r, s), an ending time et(r, s), a starting location startloc(r, s) and an ending location endloc(r, s). For each shift s, resource r needs to start from startloc(r, s) at or after st(r, s) and be back at endloc(r, s) by et(r, s).

### 2.2 Work Orders

In one implementation, each work order w comes with a location, time windows defining when the resource can arrive, priority and territory information, as well as lock options and booking information.

### 2.2.1 Time Windows

The time windows of the work orders are described in one implementation by up to 6 values, which are: starting and ending date, starting and ending time, and time from promised and time to promised. More particularly the starting date and ending date fields contain only a date (not time). They provide information about which days the work order can be visited by a resource. The starting time and ending time fields contain only a time (not date). They define a time interval during which the work order can be visited. The time from promised and time to promised fields contain both a date and a time.

The foregoing fields are not all mandatory. For example, assume there is a work order with starting and ending dates, but the starting and ending times are missing. In that case, the work order can be served any time during the permitted days. In another example, assume there are no starting and ending dates, but there are starting and ending times in a work order. In that case, the work order can be served any day, as long as it is during the permitted time period. Another example involves a work order where all starting and ending dates and starting and ending times are available. In that case, the work order can be visited only during the permitted days and, also, during the permitted time period. In a case where the time from promised and time to promised are available, then the promised time window considered is one that satisfies the promised starting and ending date/times, and also falls in the periods defined by starting and ending dates and starting and ending times. For instance, consider a starting date value of “6-23-16”, an ending date of “6-26-16”, a starting time of “9 am” and an ending time of “7 pm”. If the time from promised is “6-24-16 5 pm” and the time to promised is “6-25-16 1 pm”, then the promised time window is from “6-24-16 5 pm” to “6-24-16 7 pm” and from “6-25-16 9 am” to “6-25-16 1 pm”.

### 2.2.2 Booking Information

Each work order might come with some booking information. This may consist of a resource and/or time constraints. The fields that define the time constraints are similar to the ones described in the previous section: starting and ending date, starting and ending time, and time from promised and time to promised.

If a work order has booking information, the following contingencies can apply. If there are values in the fields time from promised and time to promised of the booking, then the work order can be scheduled any time inside the permitted time window defined by these two values (time from promised and time to promised). If there are no values in the fields time from promised and time to promised of the booking, but there are values in either of the starting and ending date or starting and ending time of the booking, then the work order needs to be scheduled in the time windows defined by these values (still considering all other constraints). If none of these six fields have values, then only the six fields of the previous section are taken into account to define the permitted time windows of the work order.

### 2.2.3 Locks

Each work order comes with a lock option. If the value of the field is “None”, then there is no lock and, if there is a booking for that work order, this booking is allowed to be deleted. The remaining lock options are: Resource, Time, Resource+Time, and Time range/window. More particularly, if the Resource lock option is invoked, the work order is served by the specific resource. The time of the visit can be anytime inside the specified window. If the Time lock option is invoked, the arrival time of the resource at the work order is exactly the one specified in the booking. Any resource can visit the location associated with that work order as long as the resource is compatible and the exact arrival time can be met. If the Resource+Time lock option is invoked, the work order is served by the specific resource, which must arrive at the location associated with the work order at the exact time specified in the booking. If the Time range/window is invoked, any resource can serve the work order, as long as it can arrive during the specific time range/window.

If a work order comes with any of these four lock options, then either it will be served according to the constraints imposed by its lock, or it will not be served at all.

### 2.2.4 Priority

In one implementation, the priority of each work order is an integer from 1 to 10 (1 denoting the lowest priority and 10 the highest).

### 2.3 Compatibility of Resources and Work Orders

A resource r can serve a work order w only if they are compatible. In one implementation, this compatibility is determined by the following. Each work order can come with one territory, while resources may have multiple territories. In order for a work order to be eligible for a resource, the territory of the work order must belong to the set of territories of the resource. In the case where a work orders does not specify a territory, it is assumed that any resource can serve the work order, as long as there is skills/characteristics and time compatibility, as will now be described.

Work orders and resources may or may not also have skills/characteristic attributes. In the case where a work order comes with a set of skills/characteristics, the visiting resource needs to have at least these skills/characteristics. If a resource does not have any identified skills/characteristics, it can serve only work orders with no skills/characteristics. If a work order has no listed skills/characteristics requirements, it can be served by any resource. Still further, in order for a resource to visit a work order location, there must be a schedule in which the resource leaves from the starting location after the starting time, travels to the work order location and returns to the ending location by the ending time (maybe visiting other work orders in the meanwhile), and, moreover, the arrival time at the work order location is inside the permitted time window of that work order.

### 3.0 Preprocessing

The resource scheduling implementations described herein can employ the following pre-processing actions to facilitate the generation of resource schedules, as will be described in more detail in subsequent sections.

### 3.1 Unique Resource ID Per Shift

In order to handle the aforementioned shifts of the resources more easily, a unique identifier can be employed for each of them. More specifically, for each resource r and each shift sϵSᵣ, a new resource rₛ is introduced. The attributes of this resource are as follows. Each new resource has a starting and ending date/time. More particularly, the time period that the new resources are active is defined by the respective shift: st(rₛ)=st(r,s) and et(rₛ)=et(r,s). Each new resource also has a starting and ending location. The starting and ending location for a new resource is defined as: startloc(rₛ)=startloc(r,s) and endloc(rₛ)=endloc(r,s). The ID of the new resource rₛ must be unique, so in one implementation it is defined by concatenating the ID of the corresponding resource r and the starting time of shift s. The remaining information of the new resource rₛ, such as territory and skills/characteristics, are the same as in the corresponding resource r.

The resulting set of new resources is used in the description of the resource scheduling implementations to follow. In this new resource set, each resource corresponds to one shift, so its attributes can be referred to using only its ID, without needing to specify the shift details.

### 3.2 Locked Work Orders

If a work order has a “Time” or “ResourceTime” lock, then it can only be satisfied at the time specified in the booking attribute. In this case, its time window can be replaced by the time specified by the lock. Then, the fact that the work order is locked can be ignored and just the updated time window is used to schedule the work order. If this is not possible, the work order will not be scheduled. Otherwise, its visit will take place according to its lock.

### 3.3 Eligibility Graph

As described earlier, not all resources can serve all work orders. In view of this, a list can be created for each resource with IDs of the work orders it can serve and, similarly, a list for each work order with the IDs of the resources that can visit the work order location and satisfy all the criteria associated with the work order. This defines the eligibility graph of resources and work orders. In order to determine the compatibility between a resource and a work order, the territory, skills/characteristics and time information can be examined, as described previously. Moreover, if a work order has a “Resource” or “ResourceTime” lock, the resource needs to satisfy the lock requirement. If there is a match in all criteria, then the resource ID is added to the list of the eligible resources of the work order and the work order ID is added to the list of eligible work orders of the resource.

### 3.4 Initial and Final Work Orders

In one implementation, two dummy work orders are added for each resource. One of them is called the initial work order and the other the final work order. The first corresponds to the resource r leaving the start location startloc(r) and the other to the resource arriving at the end location endloc(r). Both have a zero duration, a start/end time equal to the start/end time of the resource and a location equal to startloc(r) (for the initial work order) and endloc(r) (for the final work order). These two dummy work orders can only be served by their corresponding resource.

### 3.5 Time Transformations

In order to handle the date/time information in the solutions that will be described shortly, in one implementation this information is first transformed into a more convenient form. This is done by first selecting the earliest date/time of the data as a point of reference and then expressing everything as the number of time increments (e.g., minutes) that have elapsed since the reference point.

### 3.6 Decomposition

The eligibility graph can be thought of as a bipartite graph, where the two sets of vertices are the set of work orders and the set of resources. Then, there is an edge (w, r) for each pair (w, r)ϵP⊆WO×R, such that work order w can be visited by resource r. If the eligibility graph consists of more than one connected component, the problem can be decomposed by considering each component independently.

More particularly, the connected components of the graph can be identified by performing a graph traversal. At first, all resources and work orders are marked as not visited. Starting from a not visited resource we proceed to all of its eligible not visited work orders. Then, from each such work order, we proceed to all of its eligible not visited resources, etc. Every time a resource or a work order is examined, its label changes to visited. The traversal stops when there is no access to any not visited resources or work orders. At that point, a connected component has been identified.

If there are resources that have not yet been visited, the above procedure can restart using another resource in order to obtain the next connected component. All components have been completed when all resources are marked as visited. The techniques that are presented in the remaining sections are then applied independently for each component.

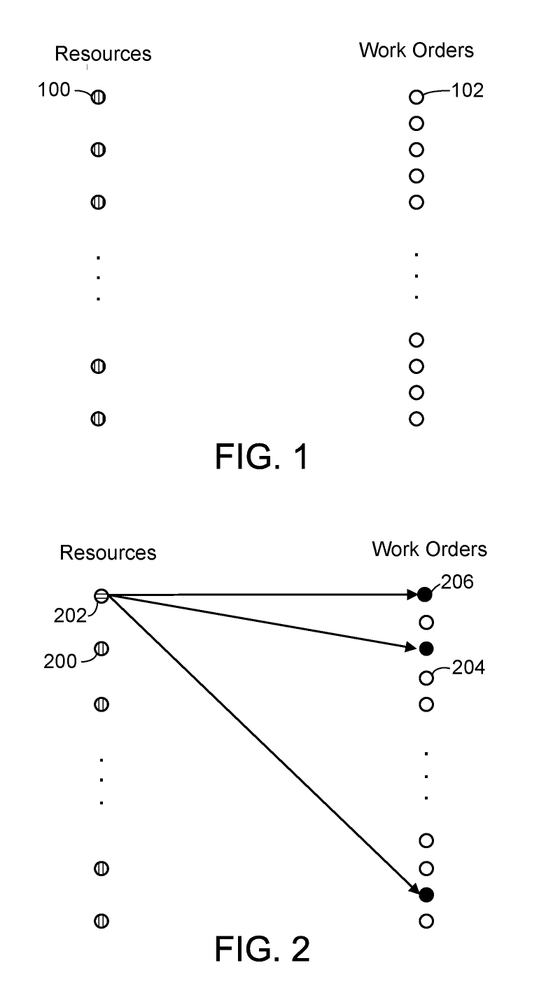

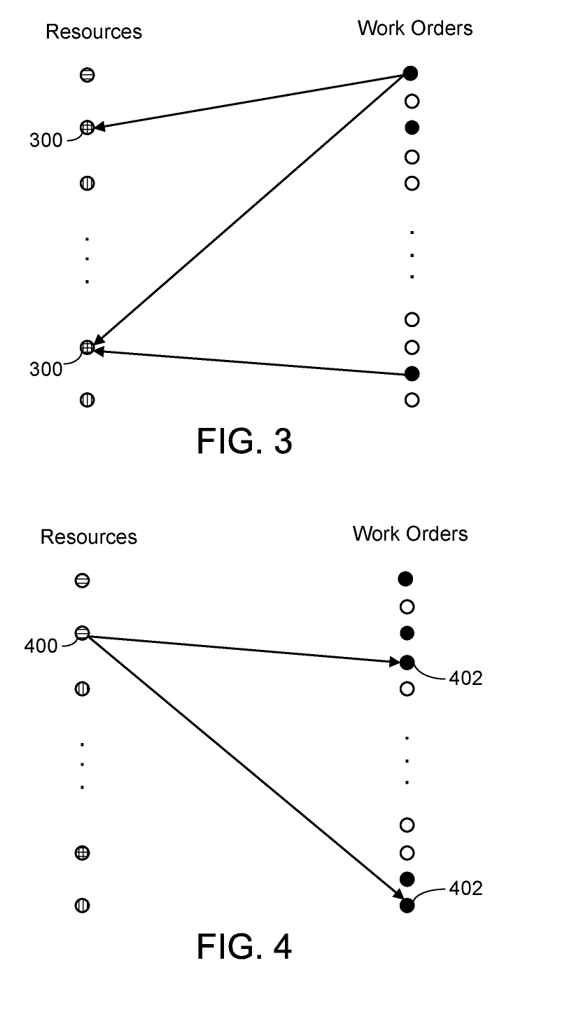

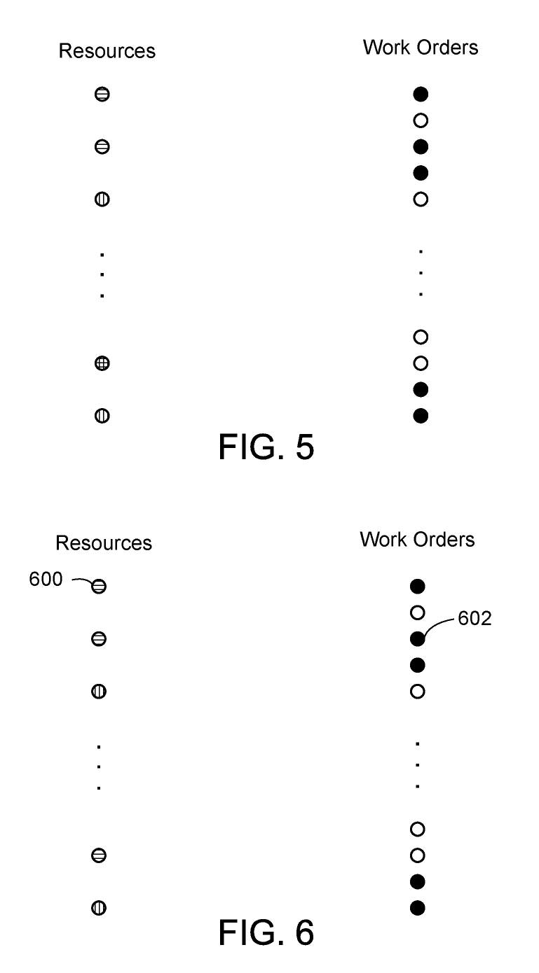

An illustrative example of the decomposition process will now be provided with reference to FIGS. 1-6. Referring to FIG. 1, consider all resources and work orders as nodes of a graph. At first, none of the resources are examined. The vertically hashed circles 100 represent resources that have not been examined. Similarly, initially none of the work orders have been visited and are represented using the open circles 102. Referring now to FIG. 2, a resource is selected that has not yet been examined (vertically hashed circle) 200 as a start of the first (or next) component. A horizontally hashed circle 202 is used to show the resources that have already been examined. From the selected resource, all work orders that the resource is allowed to visit and have not already been visited (open circles) 204 are visited. Work orders that are visited are shown as solid circles 206 in FIG. 2. As shown in FIG. 3, for each work order that was just visited, all the other resources that could serve it and that have not already been examined in a set of “active” resources are added. These are denoted with a double hashed circle 300 and are the resources that need to be examined in the near future. Next, as shown in FIG. 4, another resource 400 from the active resources is selected and the work orders 402 it can visit are marked as visited. Work orders that have already been visited by a resource are not visited again when examining another resource. Next, as shown in FIG. 5, for each work order that was just visited, its resources are added in the active set, unless they have already been considered. Assume here for simplicity that no new resource is to be added. Finally, as shown in FIG. 6, consider the last active resource of the set. Assume for simplicity this resource cannot visit any work orders that have not already been visited. In this case, the set of active resources is empty. That means that the component has been completed. The component consists of all considered resources (vertically hashed circles) 600 and all visited work orders (solid circles) 602. These are then removed from the set of resources and work orders, and only the unexamined resources and unexamined work orders remain. A new resource is picked at random from the set of unexamined resources and the same process is repeated to generate the next component. When all the resources are examined, the component generation is complete. One implementation of the foregoing decomposition procedure to identify connected components is shown below in pseudo code form.

| | |
|---|---|
| 1: | procedure DECOMPOSITION |

| | |
|---|---|
| 2: | Components ← ∅ |
| 3: | Mark all resources and work orders as not visited. |
| 4: | ActiveResources ← ∅ |
| 5: | while not all resources are visited do |

| | |
|---|---|
| 6: | Select a non visited resource r and mark it as visited. |
| 7: | ActiveResources← {r}, ComponentResources←∅, ComponentWorkOrders←∅. |
| 8: | repeat |

| | |
|---|---|
| 9: | Remove a resource r from ActiveResources. |
| 10: | ComponentResources← ComponentResources∪{r}. |
| 11: | for all work orders w eligible for r do |

| | |
|---|---|
| 12: | if w is not visited then |

| | |
|---|---|
| 13: | ComponentWorkOrders←ComponentWorkOrders∪{w}. |
| 14: | Mark w as visited. |
| 15: | for all resources r′ eligible for w do |

| | |
|---|---|
| 16: | if r′ is not visited then |

| | |
|---|---|
| 17: | Mark r′ as visited. |
| 18: | ActiveResources←ActiveResources∪{r′}. |

| | |
|---|---|
| 19: | end if |

| | |
|---|---|
| 20: | end for |

| | |
|---|---|
| 21: | end if |

| | |
|---|---|
| 22: | end for |

| | |
|---|---|
| 23: | until ActiveResources = ∅ |
| 24: | Components← Components∪{(ComponentResources,ComponentWorkOrders)}. |

| | |
|---|---|
| 25: | end while |

| | |
|---|---|
| 26: | end procedure |

### 4.0 Integer Programming Model

### 4.1 Formulation

A binary variable z(w,r) is introduced if a work order w is satisfied by resource r, i.e (w,r)ϵP. In addition, the binary variable y(w) is established to denote whether work order w is satisfied. Given these variables:

Σ_{rϵR}z(w,r)=y(w)≤¹. (1)

The two dummy work orders corresponding to the initial and the final work order must be satisfied. More particularly,

y(w)=1 ∀wϵ{startloc(r),endloc(r)} (2)

For each pair of work orders w,w′ and resource r that can satisfy both w and w′, the variable x(w,w′,r) is used which is set to 1 if resource r travels from w to w′. Of course, a resource travels only if it services both these work orders. Given this:

x(w,w′,r)≤z(w,r) (3)

x(w,w′,r)≤z(w′,r) (4)

The following constraints are also considered, which say that if r visits w, then r must get out of the location associated with w and much reach the location associated with w from somewhere. These constraints hold for all but the starting and ending vertices:

Σ_{w′}x(w,w′,r)=z(w,r)∀w≠endloc(r) (5)

Σ_{w}x(w,w′,r)=z(w′,r)∀w≠startloc(r) (6)

Variable t(w,r) denotes the time at which resource r arrives at work order w if it arrives, else it is set to M, a large number. Thus,

t(w′,r)+M·(1−x(w,w′,r))≥t(w,r)+(dur(w)+dt(loc(w),loc(w′))) (7)

st(w)≤t(w,r)≤et(w)+M·(1−z(w,r)) (8)

Finally, for each resource, the total duration of served work orders and the traveling times cannot surpass the total amount of time that the resource is available. Thus,

Σ_{w,w′}x(w,w′,r)(dur(w)+dt(loc(w),loc(w′)))≤et(r)−st(r) (9)

### 4.2 Objectives

If the goal is to maximize the total number of work orders, then the objective function is given by:

Σ_{w}y(w) (10)

If the goal is to maximize the total duration of the work orders that are served (working hours), then the objective function is given by:

Σ_{w}dur(w)y(w) (11)

If the goal is to minimize the total travelling time of the resources, then the objective function is given by:

Σ_{w,w′,r}x(w,w′,r)dt(loc(w),loc(w′)) (12)

If the goal is to maximize the priority of the working orders, let prior(w) denote the priority of work order w and then maximize the objective function given by:

Σ_{w}p(w)y(w) (13)

If the goal is to maximize the number of locked work orders, only the locked work orders are considered, and then maximize the objective function given by:

Σ_{w:w is locked}y(w) (14)

### 4.2.1 Multiple Objectives

The foregoing objectives can also be combined by introducing appropriate weights. In the special case where the objectives are prioritized, the optimization can be done in multiple stages. For a simple example, suppose the goal is to maximize the total work time, and, among the schedules with the largest work time, we want to select the ones that minimize the total traveling time for the resources. In one implementation, this can be accomplished by optimizing a combined weighted objective function, with a large weight given to the work time objective. Alternately, in a two step scenario, the first step involves optimizing over the work time using the foregoing Eq. 11 to get an optimal solution; and then adding an extra constraint that the work time needs to be equal to its optimal value, and the foregoing Eq. 12 is optimized for the traveling time.

### 4.3 Initial Solution

Given the foregoing integer programming model, a greedy algorithm process is employed to provide an initial solution. The idea is to further decompose each of the previously discovered connected components. This leads to smaller sub-problems for which a good feasible solution can be more easily found.

The second decomposition is time based. More specifically, one subcomponent for each day is created, which includes all resources and work orders that are available during some part of that particular day. Then, the integer programming model is used to get a solution for each day. Since optimality of the solution is not necessary at this point, a time limit is imposed to the solver, so that a feasible solution is quickly obtained.

Although solving the sub-problems in any order will still provide a feasible solution, a heuristic-based approach can be employed to improve the quality of the solution. In particular, the days will be considered in order of increasing number of work orders. The reason behind this choice is to prioritize the days that have less available work orders and are, in a sense, more “selective”.

More particularly, when a work order is visited in the solution of some sub-problem, it is then removed from the set of available work orders of the remaining days, in order to ensure that no work order is visited more than once. Thus, in the sub-problems of the remaining days, the resources can choose only among the work orders that have not already been visited in a different day.

If a day with few available work orders is one of the last days to be examined, it is more probable that most of its work orders have already been served in a previous day compared to a day with many work orders. In this case, the resources of that day have no choice but to remain idle most of the time, which may be the cause of a solution of worse quality.

One implementation of the foregoing second decomposition procedure to provide an initial solution is shown below in pseudo code form.

| | |
|---|---|
| 1: | procedure INITIALSOLUTION |

| | |
|---|---|
| 2: | Solution ← ∅. |
| 3: | Mark all work orders as not visited. |
| 4: | Find the work orders that are available each day. |
| 5: | SortedDays ←Days sorted in increasing number of work orders. |
| 6: | for each day in SortedDays do |

| | |
|---|---|
| 7: | Resources ←Resources available during day. |
| 8: | WorkOrders ←Work orders avail. during day marked as not |
| | visited. |
| 9: | SolutionDay ←MODEL(Resources,WorkOrders) |
| 10: | for each workOrder in SolutionDay do |

| | |
|---|---|
| 11: | Mark workOrder as visited. |

| | |
|---|---|
| 12: | end for |
| 13: | Solution ←Solution∪SolutionDay. |

| | |
|---|---|
| 14: | end for |

| | |
|---|---|
| 15: | end procedure |

### 4.4 Parameter Selection

There are certain parameters, which influence the performance of the Initial Solution procedure. First, there is a greedy time limit. As described earlier, a greedy algorithm process is used to obtain an initial feasible solution for the formulation. This algorithm solves an optimization problem for every day. Since at this point it is not necessary to solve the problem optimally, but instead to obtain a quick feasible solution, a time limit is imposed on the solver. This limit depends on the size of the problem. More specifically, when solving for a specific day, the time limit is proportional to the number of resources that are available that day. In a tested implementation, ten seconds per resource was selected as a satisfactory time limit.

Another parameter is the component time limit. After the initial solution has been found, the whole component is solved. A time limit is again used. Imposing a time limit means that there is a chance that the time is not enough for the solver to find or verify the optimal solution. The time limit can be selected either as a constant number per component or a constant number per resource, so that larger components are allowed more time. Ten seconds per resource is an example of a time limit that can be used, but any other value works as well, depending on the time constraints or the level of importance attached to optimality of the solution.

### 5.0 Path-Based Solution

The following definitions apply to a path-based solution implementation. First, given a resource rϵR, a path Pᵣ is defined as an ordered set of work orders W⊆WO. In addition, a path Pᵣ that corresponds to the ordered set of work orders W⊆WO is characterized as feasible if:

1. All work orders wϵW are eligible for resource r;
2. The first work order of W is the initial work order for resource r;
3. The last work order of W is the final work order for resource r; and
4. Resource r can start from the start location startloc(r) at or after the starting time st(r), arrive at all work orders wϵW during their time windows and spend at least the dur(w) time at each work order, and return to the ending location endloc(r) by the ending time et(r).

### 5.1 Formulation

A binary variable x(Pᵣ,r) is introduced for each resource rϵR and each of its feasible paths Pᵣ. This variable is equal to 1 if resource r follows the path Pᵣ and 0 otherwise. Thus,

x(Pᵣ,r)ϵ{0,1}∀r,Pᵣ (15)

Since each resource can follow at most one path, this gives:

Σ_{P}x(P,r)≤1 (16)

A binary variable y(w) is also introduced for each work order wϵWO. This variable is equal to 1 if the work order is served by a resource or 0 otherwise. Thus,

y(w)ϵ{0,1}∀w (17)

A work order wϵWO is visited only if there at least one resource that selects a path that contains w. Thus,

y(w)≤Σᵣ [symbol] x (P,r)∀w (18)

If the objective is to maximize the number of work orders, then:

max Σ_{w∉{startloc(r),endloc(r)}}y(w) (19)

### 5.2 Column Generation

The foregoing maximization problem might have a very large number of variables due to the large number of feasible paths that may exist. For this reason, a method that can be used for its solution is column generation. In particular, not all paths need to be generated from the beginning. The problem can start with a small number of variables x(Pᵣ, r), which correspond to a small number of paths, and then gradually generate more and add the corresponding variables to the model. The question now is which are the variables that should be added to the model. The first step to answering that question is to create the dual of the above model. In order to do that a primal is introduced, which is the relaxation of the formulation presented in section 5.1.

More particularly, consider Eq. 19

max Σ_{w∉{startloc(r),endloc(r)}}y(w)

subject to the following constraints:

y(w)≤1 ∀w (20)

y(w)≤Σᵣ [symbol] x(Pᵣ,r)∀w (21)

Σ_{P}_{ᵣ}x(Pᵣ,r)≤1 ∀r (22)

y(w)≥0 ∀w (23)

x(Pᵣ,r)≥0 ∀r,Pᵣ (24)

In order to create the dual, a variable p_{w} is introduced for each constraint as defined in Eq. 20, a variable q_{w} is introduced for each constraint as defined in Eq. 21, and a variable sᵣ is introduced for each constraint as defined in Eq. 22. Thus,

min Σ_{w}p_{w}+Σᵣsᵣ (25)

subject to the following constraints:

p_{w}q_{w}≥1 ∀w∉{startloc(r),endloc(r)} (26)

p_{w}q_{w}≥0 ∀wϵ{startloc(r),endloc(r)} (27)

−Σ_{w∈P}_{ᵣ}q_{w}+sᵣ≥0 ∀r,Pᵣ (28)

p_{w}≥0 ∀w (29)

q_{w}≥0 ∀w (30)

sᵣ≥0 ∀r (31)

Since each variable of the foregoing primal corresponds to a constraint of the dual, the above problem has a very large number of constraints. It is, however, possible to start by including only a subset of them. For example, in one implementation, the problem can be initially limited to the constraints defined in Eqs. 26 and 27, and some of the constraints defined in Eqs. 28. The problem is solved for these constraints, and then it is determined if one of the remaining constraints is violated by the solution. If such constraint exists, the corresponding path P needs to be generated and the variable x(P,r) is then added to the primal. If there is no violated constraint found, then the solution is optimal.

In order to find a violated constraint, a separation problem needs to be formulated. Since all remaining constraints are of the form as defined in Eq. 28, a constraint is violated if there exists a resource r and a feasible path for the resource Pᵣ such that −Σ_{w∈P}_{ᵣ}q_{w}+sᵣ<0. It is then possible to minimize −Σ_{w∈P}_{ᵣ}q_{w}+sᵣ over all resources r and paths Pᵣ. If the solution is greater or equal to 0, then no constraint is violated and the solution is optimal. Otherwise, the resource r and path Pᵣ for which −Σ_{w∈P}_{ᵣ}q_{w}+sᵣ<0 define a violated constraint.

The minimization problem can be solved for each resource separately. So, for each resource r:

minₚ_{ᵣ}−Σ_{w∈P}_{ᵣ}q_{w}sᵣs.t. Pᵣ is a feasible path for r (32)

This can be written equivalently as:

min_{Pr}−Σ_{w∈P}_{ᵣ}q_{w}s.t. Pᵣ is a feasible path for r (33)

or:

max_{Pr}Σ_{w∈P}_{ᵣ}q_{w}s.t. Pᵣ is a feasible path for r (34)

This is solved for every resource r. If for every r the result is less or equal than sᵣ, an optimal solution has been reached, otherwise a violated constraint has been found. All violated constraints are added to the dual problem, which is solved again, and this procedure is repeated until no violated constraint exists.

When the optimal solution of the dual has been found, the primal problem with the integrality constraints can be solved. In some cases, an integrality gap may occur, i.e., there is a difference between the optimal value of the program and the one of its relaxation. This gap is generally small and can be ignored.

The maximization sub-problem for each resource r can be solved using the M-formulation and considering only the work orders that are compatible with r. However, this might require a significant amount of time, so a combinatorial method is proposed as will be described shortly.

### 5.3 Initialization

This section describes one implementation of an initialization procedure for generating an initial set of paths that is used when the aforementioned dual problem is solved for the first time. This set of paths needs to be large enough so that not many iterations are needed when solving the dual. However, some caution is required, since a large number of paths corresponds to a large number of constraints, which increases the size of the problem and delays the optimization.

In the initialization, the focus is placed on generating short paths. In particular, each resource is initialized with a path of zero length, where it just goes from the starting to the ending location. Then, all paths of length one are generated. These are the paths where the resource visits exactly one work order. In order to generate paths of length two, it is attempted to extend the paths of length one by adding work orders at the end (before the return to the ending location), while at the same time maintaining feasibility. The path generation continues in order of increasing length, each time by trying to extend the previously created paths, until in one implementation a pre-specified number of paths have been generated or no more feasible paths exist.

One implementation of the foregoing initialization procedure to provide an initial set of paths that are used when the dual problem is solved for the first time, is shown below in pseudo code form. In this implementation, the set Paths contains all paths that have been generated so far for each resource. The set PathsToExtend contains all paths that have been generated but which have not yet been examined to see if more work orders can be added at their ends.

| | |
|---|---|
| 1: | procedure GETINITIALPATHS |

| | |
|---|---|
| 2: | for each resource r do |

| | |
|---|---|
| 3: | Paths(r) ←{[ ]}, PathsToExtend(r) ←{[ ]} |

| | |
|---|---|
| 4: | end for |
| 5: | while true do |

| | |
|---|---|
| 6: | for each resource r do |

| | |
|---|---|
| 7: | {Paths(r), PathsToExtend(r)}←EXTENDPATHS(r,pathsToExtend(r),paths(r)) |
| 8: | if number of paths ≥ MaxNoPaths then |

| | |
|---|---|
| 9: | return |

| | |
|---|---|
| 10: | end if |

| | |
|---|---|
| 11: | end for |
| 12: | if no new path has been found then [symbol] All paths have been generated |

| | |
|---|---|
| 13: | return |

| | |
|---|---|
| 14: | end if |

| | |
|---|---|
| 15: | end while |

| | |
|---|---|
| 16: | end procedure |

The extension of a path needs to ensure feasibility. Suppose w is the last work order of a path Pᵣ and denote with T_{w}^{end} the earliest time that resource r can complete its visit at w. A work order w′ can be added at the end of the path Pᵣ, if w′ is compatible with r, and w′ is not already part of the path Pᵣ. In addition, w′ must be able to be visited inside its time window. For example, let T_{w′}^{start} denote the earliest time resource r can start serving w′. Then:

T_{w′}^{start}=max(T_{w}^{end}+dt(loc(w),loc(w′),st(w′))≤et(w′) (35)

Still further, r must be able to return to its end location after visiting w′ by its ending time et(r). Thus,

T_{w′}^{start}+dur(w′)+dt(loc(w′),loc(r))≤et(r) (36)

One implementation of the foregoing path extension procedure is shown below in pseudo code form.

| | |
|---|---|
| 1: | function EXTENDPATHS(r,PathsToExtend,Paths) |

| | |
|---|---|
| 2: | NewPathsToExtend ←∅ |
| 3: | for each Path in PathsToExtend do |

| | |
|---|---|
| 4: | for each work order w′ compatible with r do |

| | |
|---|---|
| 5: | if number of paths ≥ MaxNoPaths then |

| | |
|---|---|
| 6: | return {Paths, NewPathsToExtend} |

| | |
|---|---|
| 7: | end if |
| 8: | if Path contains w′ then |

| | |
|---|---|
| 9: | continue |

| | |
|---|---|
| 10: | end if |
| 11: | w←last work order of path [symbol] Initial dummy work |
| | order if path empty |
| 12: | T_{w′}^{start} = max (T_{w}^{end} + dt(loc(w), loc(w′)), st(w′)) |
| 13: | if T_{w′}^{start} > et(w′) then [symbol] Cannot visit work order in its |
| | time |

window

| | |
|---|---|
| 14: | continue |

| | |
|---|---|
| 15: | end if |
| 16: | if T_{w′}^{start} + dur(w′) + dt(loc(w′), loc(r)) > et(r) then |

[symbol]

Cannot return in time

| | |
|---|---|
| 17: | continue |

| | |
|---|---|
| 18: | end if |
| 19: | Path←Path ∪ w′ |
| 20: | NewPathsToExtend ←NewPathsToExtend ∪ Path |
| 21: | Paths ←Paths ∪ Path |

| | |
|---|---|
| 22: | end for |

| | |
|---|---|
| 23: | end for |
| 24: | return {Paths, NewPathsToExtend} |

| | |
|---|---|
| 25: | end function |

After the initial set of paths has been generated, the initial and final dummy work orders are added to the beginning and end of each path. This is the set of paths that will be used in the column generation when the dual problem is solved for the first time.

### 5.4 Combinatorial Procedure

At each iteration of the column generation procedure, it is necessary to check if there are constraints that are violated by the “current” solution. If constraints are violated, they are added to the dual, which is then solved again, otherwise the current solution is optimal and the procedure terminates.

As described previously, the constraints that are checked are of the form −Σ_{w∉P}_{ᵣ}q_{w}+sᵣ≥0, and there is one such constraint per feasible path Pᵣ. A constraint is violated by the current solution if Σ_{w∉P}_{ᵣ}q_{w}<sᵣ. Consider q_{w} as a weight assigned to work order w and sᵣ as a weight assigned to resource r. Then, a feasible path Pᵣ of a resource r corresponds to a violated constraint, if the total weight of the work orders it visits exceeds the weight sᵣ of the resource. Thus, sᵣ can be thought of as a threshold value. Given this, a combinatorial procedure can be developed that quickly generates paths whose total work orders' weight exceeds the corresponding threshold value, or verify that no such path exists.

### 5.4.1 Concepts

For each resource r, feasible paths are generated, which by definition contain only work orders that are compatible with r. It is then determined whether these paths violate the aforementioned constraint or not. The combinatorial procedure accomplishes this task as follows.

Before starting the path generation, it is advantageous to reduce the size of the problem by removing all work orders w with q_{w}=0 (if any). These work orders do not contribute to the sum of weights Σ_{w∉P}_{ᵣ}q_{w}, so if a path that contains such work orders exceeds the threshold, it will still exceed it if these work orders are removed. Since it is not necessary to find all violating paths, but only a subset of them, work orders with q_{w}=0 can be safely ignored.

In addition, since all remaining q_{w} are positive numbers, longer paths with more work orders are more likely to exceed the threshold. For that reason, the focus of the procedure is placed on generating long paths. So, existing paths are extended by adding as many work orders as possible, before continuing with the generation of new paths.

Giving priority to large weights q_{w} is also advantageous. In order to find violating paths quickly, work orders are examined in order of decreasing q_{w}. At each point, the work order w with the highest q_{w} is removed from the set of work orders, and all paths that contain w and a subset of the remaining work orders are generated. Then, the next highest q_{w} is similarly processed, and so on, until all work orders have been examined. At each iteration, let the term main work order denote the work order with the currently highest weight value q_{w}.

It is further advantageous to quickly generate, for each iteration over the set of work orders, all paths that visit the main work order. In order to achieve that, it is possible to create all feasible sub-paths that end with the main work order and all feasible sub-paths that start with the main work order, and then combine them. Feasibility needs to be maintained during the sub-path generation, as well as the combination of subpaths.

Instead of merely maintaining a list with the sub-paths that the procedure creates, in one implementation, a more advantageous data structure is employed. In particular, when examining a “current” main work order, two trees are created. The first one includes all the sub-paths that end with the current main work order and the second includes all the sub-paths that start with the current main work order. Each node of a tree corresponds to exactly one sub-path. A more detailed description of the tree data structure, and the sub-path generation process in general, will be provided in section to follow.

One of the advantages of the tree data structure is that it provides the possibility of pruning. More specifically, by maintaining the necessary information at each tree node, it is possible to know in advance if combining any sub-paths of two sub-trees will lead to paths that are not feasible and to paths that do not violate the aforementioned constraint. Thus, the performance of the combinatorial procedure can be increased by not examining the merging of these sub-trees any further.

If at any point the total weight of the set of remaining work orders does not surpass the threshold value, then the procedure can be terminated. This is due to the fact that any path that contains any subset of these work orders cannot exceed the threshold value and, thus, no more violating paths can be created.

### 5.4.2 Tree Data Structure

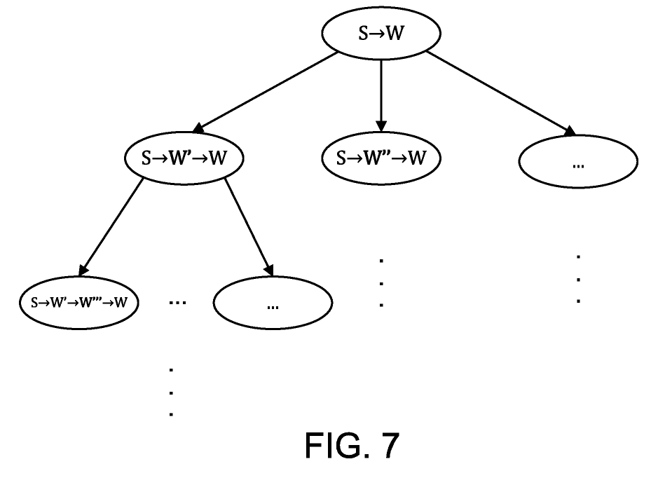

Each node of the tree data structure corresponds to one sub-path. The root is a sub-path of length one, where only the main work order is visited. The sub-paths of the rest of the nodes are generated by inserting one work order at the sub-path of their parent node. An illustrative example is shown in FIG. 7 where all paths start from the starting location of the resource and end with the visit of w. More particularly, suppose s represents the start location of the resource and w is the current main work order. In order to build the tree, given the path of a node, an attempt is made to add new work orders before the main work order w. Each new path that is created corresponds to a child of a node in the tree. The bolded characters in FIG. 7 show the new work order that was added to the path of the parent when the child was created.

The information each tree node needs to have is as follows. First, complete information about the sub-path is included. This includes the work orders in the order they are visited, as well as useful information such as the total weight of the sub-path and the time the resource is available to visit other work orders. The goal is to be able to add work orders to the path quickly, without needing to recalculate the arrival times at each work order of the path in every iteration in order to ensure feasibility. The maximum weight that can be achieved in any sub-path of the sub-tree that is rooted at the node under consideration is also included. This quantity is used for the pruning of sub-trees that cannot lead to a violating path. Finally, information that allows access to all the node's child nodes is included.

### 5.4.3 Subpath and Tree Generation

As indicated previously, for each main work order, two trees are created: one where the main work order is the last work order that is visited and one where it is the first. The construction of the first tree will now be described. Construction of the second is similar.

The tree starts with only one node, the root, which corresponds to the sub-path where the resource starts from the start location and then visits only the main work order. Then, all remaining work orders are examined to find one of them that can be inserted before the main work order. If that leads to a feasible sub-path, i.e., both the new and the main work order are visited in their time window and the resource has enough time to return to the end location, a new tree node, child of the previous one, is created. The extension of the sub-path, and thus the construction of the tree, continues by repeating the foregoing process of adding work orders immediately before the main work order, until no more such insertions is possible. The process is then repeated in an attempt to create additional sub-paths using the remaining work orders that are not already part of a sub-path. The resulting tree includes all feasible sub-paths where the resource starts from the start location and ends at the main work order, maybe visiting one or more of the other work orders in between.

In order to achieve fast extension of the sub-paths, for each sub-path being generated, information is retained that facilitates a quick decision on if a work order can be inserted or not. More specifically, for a sub-path pᵣ with a main work order w, let Tₚ_{ᵣ}^{endE} denote the earliest time that the resource can finish visiting all work orders but the main one. At first, where only the main work order is visited, Tₚ_{ᵣ}^{endE} is equal to the starting time of the resource, i.e., Tₚ_{ᵣ}^{endE}=st(r).

Similarly, let T_{w}^{startL} denote the latest time that the main work order w can be visited. In the calculation of T_{w}^{startL} both the time window of w and the need of the resource to return to its end location endloc(r) after that by the ending time e(t) are taken into account. So,

T_{w′}^{startL}=min(et(w),et(r)−dt(loc(w),endloc(r))−dur(w)) (37)

Suppose wₗₐₛₜ is the last work order that is visited by r in pᵣ before the main work order w. In the beginning, wₗₐₛₜ is the dummy initial work order for r. Suppose now it is desired to insert a work order w′ that is compatible with resource r and is not already part of the sub-path pᵣ. The earliest time T_{w′}^{startE} that this work order can be reached is given by:

T_{w′}^{startE}=max(Tₚ_{ᵣ}^{endE}+dt(loc(wₗₐₛₜ),loc(w′)),st(w′)) (38)

If this time is not inside the time window of w′, then w′ cannot be visited at a permitted time and, thus, cannot be added to the sub-path. This is the case if:

T_{w′}^{startE}>et(w′) (39)

Then, it is determined if resource r, after visiting w′, can still arrive to the main work order w during its time window and return back to endloc(r) by the ending time et(r). For that, it suffices to check if r can arrive to the main work order w by the latest permitted time T_{w}^{startL};

T_{w′}^{startE}+dur(w′)+dt(loc(w′),loc(w))≤T_{w}^{startL} (40)

If this is the case, w′ can be inserted before the main work order and lead to the generation of a feasible sub-path pᵣ′. The earliest time that r can finish all work orders but the main one in the new sub-path is then given by:

Tₚ_{ᵣ}_{^{′}}^{endE}=T_{w′}^{endE}+dur(w′) (41)

The final action is to create a new node N in the tree. This will include the new subpath pᵣ′ and the largest weight Wₘₐₓ^{N} that can be achieved in the sub-tree rooted at node N. Since this node does not have yet any children, Wₘₐₓ^{N} is initialized as the sum of the work orders of its sub-path:

Wₘₐₓ^{N}=Σ_{w″ϵp}_{ᵣ}_{^{′}}q_{w″} (42)

Then, as the tree grows, this value is updated at each node, starting from the leaves which forward their value to their parent. Each parent selects the largest Wₘₐₓ among its children.

One implementation of the foregoing procedure that generates the tree of sub-paths that end with the main work order is shown below in pseudo code form. This procedure takes as input a node that at first is the root corresponding to the sub-path that visits only the main work order w; and a tree that at first consists only of the root node; and the latest time T_{w}^{startL} that work order w can be visited.

| | |
|---|---|
| 1: | procedure GENERATEFIRSTSUBPATHS(node N, tree, T_{w}^{startL} ) |

| | |
|---|---|
| 2: | path ←the sub-path of N |
| 3: | for each work order w′ do |

| 4: | Compute the earliest time T_{w′}^{startE} that w′ can be visited using Eq. (38). | |
|---|---|---|
| 5: | if T_{w′}^{startE} > et(w′) then > | [symbol] w′ cannot be visited in its time window |

| | |
|---|---|
| 6: | continue |

| | |
|---|---|
| 7: | end if |
| 8: | Compute the earliest time T_{w}^{startE} that w can be visited using the left |

| | |
|---|---|
| side | of Eq. (40). |

| | | |
|---|---|---|
| 9: | if T_{w}^{startE}>T_{w}^{startL} then | [symbol] Not enough time to visit main work order |

and return.

| | |
|---|---|
| 10: | continue |

| 11: | end if | |
|---|---|---|
| 12: | Create new sub-path with w′ inserted before w. | |
| 13: | Create new tree node N′ and add it to the tree. | |
| 14: | Wₘₐₓ^{N′} ← Σ_{w″∈path} q_{w″} + q_{w′} | [symbol] Initialize maximum weight |
| 15: | if Wₘₐₓ^{N′} + q_{w}_{_{final}} ^{>} sᵣ then | [symbol] Sub-path with final dummy |

work order violates threshold

| | |
|---|---|
| 16: | Add sub-path with final work order to set of violating paths. |

| | |
|---|---|
| 17: | end if |
| 18: | if number of violating paths ≥ desired number then |

| | |
|---|---|
| 19: | return |

| 20: | end if | |
|---|---|---|
| 21: | GENERATEFIRSTSUB-PATHS(N′, tree, T_{w}^{startL}) | [symbol] Expand tree recursively |

| | | |
|---|---|---|
| 22: | Wₘₐₓ^{N} ← max(Wₘₐₓ^{N}, Wₘₐₓ^{N′}) | [symbol] Update maximum weight |

| | |
|---|---|
| 23: | end for |

| | |
|---|---|
| 24: | end procedure |

The procedure for generating the tree with all sub-paths that start with the main work order w is similar, but the paths are extended in a different direction. More specifically, the root node corresponds to a sub-path of length one, where resource r starts from the main work order and then returns to its end location endloc(r). At every recursive step, the goal is again to expand the path by inserting new work orders. The difference is that the new work order is inserted, if possible, right after the main work order, and not before as was happening in the previous case.

### 5.4.4 Merging the Sub-Paths

Let R_{w}¹ denote the tree with all sub-paths that end with the main work order w and R_{w}² be the tree with all the sub-paths that start with w. The next action involves merging these two trees. This will lead to the generation of all paths that contain work order w.

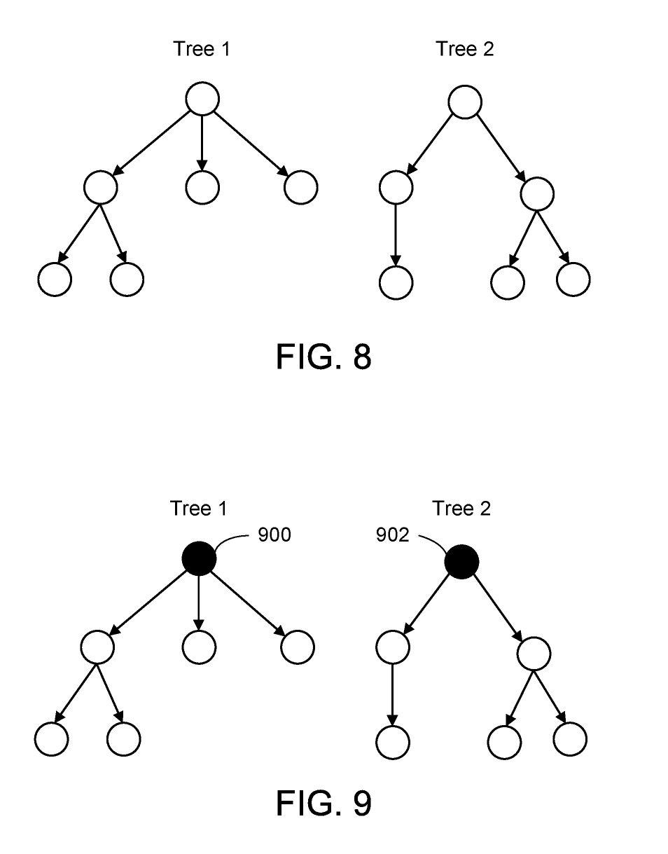

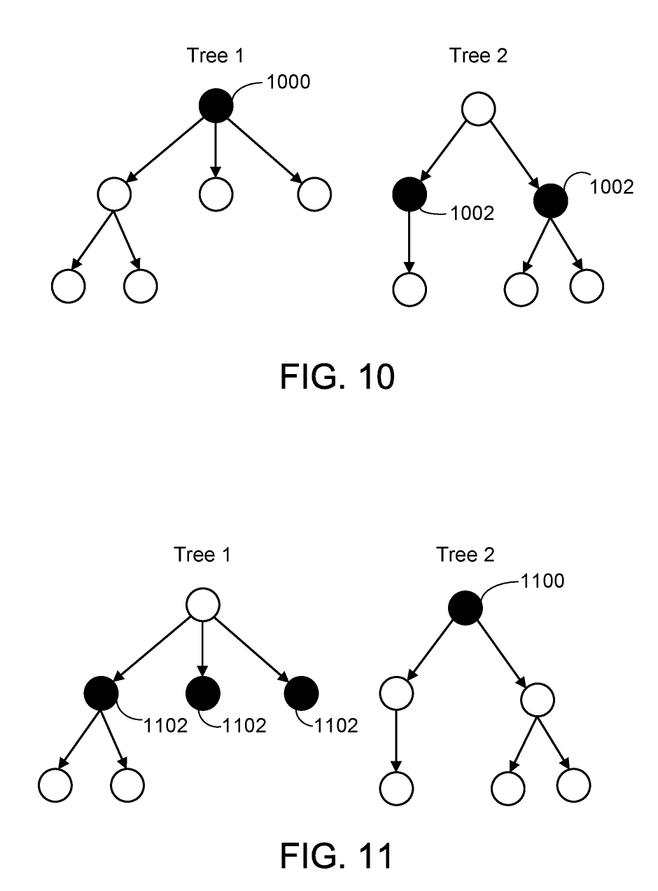

For example, referring to FIG. 8, suppose the two trees of sub-paths have been created. Tree 1 includes all sub-paths that start from the starting location of the resource and end with the visit of the main work order, and Tree 2 includes the sub-paths that start from the main work order and go to the ending location. The merging of the trees consists of tree traversals and merging one node from each tree at a time. Referring now to FIG. 9, suppose this begins by trying to combine the root 900 of the first tree with the root 902 of the second. This is not actually necessary, since both roots do not visit any other work orders besides the main one, so the procedure could have started by combining their children. Referring now to FIG. 10, every time two nodes can be combined successfully, the process is continued recursively. So, an attempt can be made to combine the first node 1000 with all the children 1002 of the second. Then, as shown in FIG. 11, an attempt is made to combine the second node 1100 with all the children 1102 of the first. Whenever two nodes cannot be combined, then their children cannot be combined either, so the combination of their sub-trees does not need to be examined and the sub-trees are pruned. When, the traversal of both trees ends, all violating paths have been created.

More particularly, the sub-path merging procedure begins by examining a node N¹ from the first tree and a node N² from the second tree. Let p¹ and p² be the corresponding sub-paths. If these sub-paths can be combined, then the traversal of the trees continues by trying to merge p¹ with all children of p², and p² with all children of p¹. If the concatenation of the sub-paths does not lead to a feasible path, then the combination of any of their children will also lead to infeasible paths (as will be described in more detail shortly), and, as a result, need not be examined.

Since the ultimate goal is to get violating paths, the search space can be reduced by pruning some combinations of sub-trees, which might be feasible but have lower weight than the threshold sᵣ. More specifically, for each node the maximum possible weight in the associated sub-tree is known. Suppose this value is Wₘₐₓ^{N}^{¹} for the first node and Wₘₐₓ^{N}^{²} for the second node. If the sum of the two weights cannot give a value greater than the threshold, then any combination of paths in their sub-trees cannot lead to a violating path. As a result, they do not need to be examined. Some attention is required since the weight q_{w} of the main work order w has been included in both Wₘₐₓ^{N}^{¹} and Wₘₐₓ^{N}^{²}. So, the inequality that, if true, leads to pruning is the following:

Wₘₐₓ^{N}^{¹}Wₘₐₓ^{N}^{²}−q_{w}≤sᵣ (43)

After verifying that there is still a chance to produce a violating path, the next action is to check if there is a work order, except from the main one, that is present in both sub-paths. If this is the case, the two parts cannot be combined since the resulting path will have a duplicate work order. Based on the way the tree traversal is performed, it is not necessary to check if each work order of one sub-path belongs to the other, but it is enough to check exactly two of them. More specifically, if the combination of two sub-paths is being examined, that means that their parents could be combined. Since the difference between each child and its parent is exactly one work order, it suffices to check whether this work order exists in both sub-paths or not. In particular, for the first sub-path, the work order that is visited right before the main work order is checked, and for the second sub-path the one that is visited right after the main work order is checked.

It is next determined whether the resource will have enough time to visit all work orders of the two sub-paths. Each sub-path that ends with the main work order w comes with information regarding the earliest time when the visits of all work orders of the sub-path can be completed. Let Tₚ_{¹}^{endE} be this time for sub-path p¹. Similarly, let Tₚ_{²}^{startL} be the latest time that the visits of the work orders of p² can start. Note that the duration of the main work order w has been included in both these times. Thus, it is possible to decide if all work orders can be served by simply checking if the following inequality is true:

Tₚ_{¹}^{endE}≤Tₚ_{²}^{startL}+dur(w) (44)

If this inequality is satisfied, then the two sub-paths can be merged. If, moreover, the total weight of the resulting path exceeds the threshold value, then it is added to the set of violating paths. In the case where the two sub-paths cannot be combined, it is obvious from the generation procedure of the tree that none of the sub-paths that belong to the sub-trees rooted at N¹ and N² can be combined. This is the case, because each child node was created by adding one more work order to the sub-path of the parent. Thus, if there is not enough time for a resource to visit the work orders of two nodes, then it can definitely not visit the work orders of any combination of their children, since they will include at least these same work orders and maybe some additional ones. This allows pruning some combinations of sub-trees during the merging procedure, and, thus, speed up its performance.

### 5.5 Additional Objectives

The objective considered in the foregoing description is the maximization of the visited work orders. However, the path-based solution implementations for resource scheduling applies to other objectives as well with only subtle differences, mainly in the formulation of the primal and the dual problem.

For example, if the objective is to maximize working hours, the objective of the primal problem becomes Σ_{w}dur(w)y(w). This leads to a difference in the dual constraints. More specifically, constraint Eq. 26 becomes:

p_{w}+q_{w}≥dur(w)∀w (45)

If the objective is to minimize traveling time, the objective of the primal problem is Σ_{r,P}_{ᵣ}x(Pᵣ, r)travelTime(Pᵣ). This time, constraint Eq. 28 of the dual becomes:

−Σ_{wϵP}_{ᵣ}q_{w}+sᵣ≥−travelTime(Pᵣ)∀r,Pᵣ (46)

So, in order to find a violating path, the sum of weights of the work orders of each path Σ_{wϵP}_{ᵣ}q_{w} is compared with the value sᵣ of the resource increased by the total traveling time of the path travelTime(Pᵣ).

If the objective is to maximize priority of the work orders, the objective is Σ_{w}prior(w)y(w) and the corresponding dual constraint is:

p_{w}+q_{w}≥prior(w)∀w (47)

If the objective is to maximize number of locked work orders, the objective is Σ_{w:w is locked}y(w). For the dual, for each locked work order:

p_{w}+q_{w}≥1∀w:w is locked (48)

### 5.6 Multiple Objectives

The foregoing objectives can also be combined by introducing appropriate weights. More particularly, right hand sides of the inequalities in the dual are weighted.

### 5.7 Multi-Step Optimization

A multi-step optimization can also be introduced, which can be helpful in cases with multiple objectives whose weights vary. Recall that the first action in the combinatorial algorithm is the size reduction of the problem. In particular, all work orders with weight q_{w}=0 are removed, since they do not contribute to the total weight of the path. Another approach is to select a threshold a qₜₕᵣₑₛ>0 and at each iteration remove the work orders w with q_{w}<qₜₕᵣₑₛ. The goal of this approach is to further reduce the number of work orders in the path generation, so that less time is required.

Threshold qₜₕᵣₑₛ starts with a large value and each time the problem is solved to optimality, i.e. no more violating paths that include the work orders with q_{w}≤qₜₕᵣₑₛ can be found, qₜₕᵣₑₛ is decreased. The optimal solution is found when no more violating paths can be added and a qₜₕᵣₑₛ has a value close to zero. The amount by which qₜₕᵣₑₛ is reduced each time, depends on the total number of distinct thresholds it is desired to examine. A number of three to five different thresholds has been found to perform well.

### 5.8 Duplicate Work Orders

The path formulation does not enforce that only one path can pass from each work order that is visited. As a result, in the final solution there might be work orders that are visited by more than one resources. This might be the case when objectives such as the work time or the number of locks is being optimized, where multiple visits to a work order are not reflected in the objective. That is not the case when minimizing the total traveling time. For this objective, the optimal solution will include at most one visit per work order. However, even for that objective, multiple visits can occur if a time limit causes an early termination of the procedure. Thus, the final solution needs to be checked and duplicate work orders need to be removed. The selection of work orders to be removed can be arbitrary, or more involved techniques can be used, for example removal of work orders that require larger traveling time.

### 5.9 Parameter Selection

The path-based solution implementations for resource scheduling include various parameters, and their values can influence performance. For example, selecting the initial number of paths is a parameter in the previously-described initialization phase that has an effect on performance. Selecting a large number of paths provides more options to the solver and less iterations might be needed in the column generation. However, having many paths requires additional time, each time the solver is called, and, thus, the total running time might be larger, even if the iterations are fewer. In tested embodiments, it was found that 1000 initial paths resulted in acceptable performance.

Another parameter that is selected, and which affects performance, is the number of additional paths. In every iteration of the column generation, a number of paths is generated for each resource. Again, if that number is too large, the solver may require more time, but if it is small, more iterations might be needed. In tested embodiments, it was found that 100 paths per resource and per iteration, resulted in acceptable performance.

The time limit per path search is another parameter that affects performance. In every iteration, it is desired to add a new set of paths to the model. The reason more than one path is added is to try to reduce the number of iterations. However, only one path can be enough. Thus, if at least one path has been found, it is possible to impose a time limit so that the search stops when the limit has been reached. This is important in cases where some paths have already been generated, but a lot of time is required to find more or maybe no more paths exist. Since at least one path is added every time, the final solution is still optimal despite this time limit.

Yet another parameter that affects performance is the traveling time limit. When traveling time is part of the objective function of the primal, it appears in the right-hand side of the constraints of Eq. 46 of the dual. This might make the optimization slower in some instances because this objective is more difficult to handle as it is not linear with respect to the work orders. Thus, it is possible to impose a time limit which will lead to earlier termination, if the optimization exceeds it. This might generate sub-optimal solutions, but since running time is an important aspect of the problem, it is advantageous.

The total time limit is yet another parameter that affects performance. In some real world applications, there might be some time restrictions which must be respected. In these cases, a non optimal solution in a reasonable time might be preferred over an optimal solution that requires much longer to compute. Thus, it is possible to impose a total time limit on the execution of the resource scheduling procedure, and if an optimal solution has not been obtained before the time limit, the procedure terminates early and a sub-optimal solution is produced.

### 6.0 Field Service Resource Scheduling System Framework

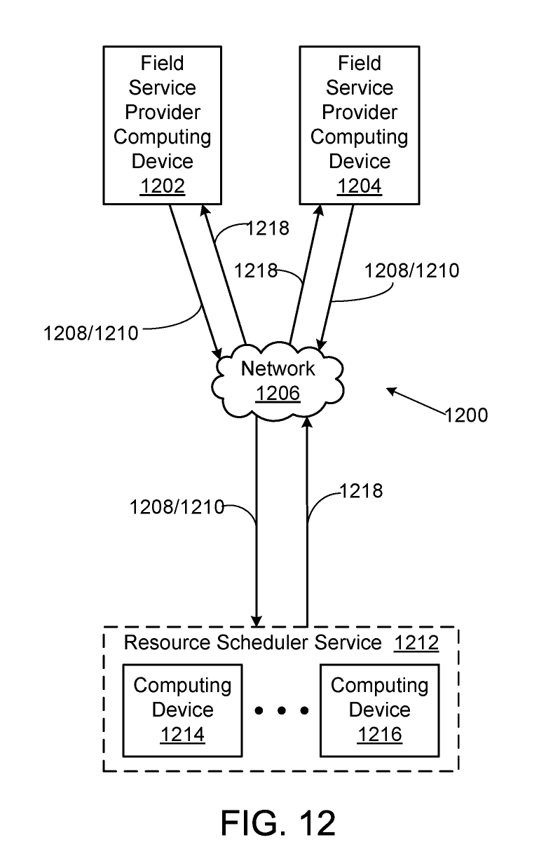

FIG. 12 illustrates one implementation, in simplified form, of a system framework for realizing the field service resource scheduling implementations described herein. As exemplified in FIG. 12, the system framework 1200 includes one or more field service provider computing devices (two of which are shown) 1202/1204 that are utilized by the field services providers as described previously. The field service provider computing devices 1202/1204 can be any type of conventional mobile computing device such as a smartphone, or a tablet computer, or a laptop computer (sometimes also referred to as a notebook or netbook computer), or a computing device that is integrated into an automobile, among other types of conventional mobile computing devices. The field service provider computing devices 1202/1204 can also be any type of conventional non-mobile computing device such as a desktop personal computer (PC), among others.

Referring again to FIG. 12, the field service provider computing devices 1202/1204 are configured to communicate over a conventional data communication network 1206 (herein also referred to as a computer network) such as the Internet (among other types of conventional data communication networks). The field service provider computing devices 1202/1204 are utilized by their associated field service providers to perform a wide variety of tasks. By way of example but not limitation and as will be described in more detail hereafter, a field service provider may utilize their field service provider computing device 1202/1204 to submit data 1208 concerning the aforementioned resources available to the field service provider, as well as data 1210 concerning the aforementioned work orders the fields service provider has agreed to fulfill.

Referring again to FIG. 12, the field service provider computing devices 1202/1204 are also configured to communicate over the data communication network 1206 with a resource scheduler service 1212 that runs on one or more other computing devices 1214/1216. These other computing devices 1214/1216 can also communicate with each other via the network 1206. In an exemplary implementation of the resource scheduling implementations described herein, the other computing devices 1214/1216 are located in the cloud so that the resource scheduler service 1212 operates as a cloud service and the network 1206 includes wide area network functionality. The term “cloud service” is used herein to refer to a web application that operates in the cloud and can be hosted on (e.g., deployed at) a plurality of data centers that can be located in different geographic regions (e.g., different regions of the world).

Referring again to FIG. 12 and as will be described in more detail hereafter, the resource scheduler service 1212 generally performs a variety of functions associated with scheduling resources to fulfill work orders for the various fields service providers. By way of example but not limitation, in an exemplary implementation of the resource scheduling described herein the resource scheduler service 1212 receives resource data 1208 and work order data 1210 from a field service provider via their field service provider computing device 1202/1204. The resource data 1208 includes the identity of resources that are capable of fulfilling one or more of the work orders associated with the field services during the course of a resource work shift. The work order data 1210 includes the identity of work orders associated with the field services, where each work order is assigned attributes identifying where and when the work order is to be fulfilled. The resource scheduler service 1212 then generates one or more schedules 1218 for each resource that, as described previously, details the work orders each resource is to fulfill, in what order and when, over the course of a resource's shift. More particularly, in one implementation, each schedule identifies a sequence of one or more work orders that can be fulfilled by the resource over the course of the resource's work shift which reflect one or more prescribed scheduling objectives (as described previously). The schedules established for the resources are established in a series of iterations, with each iteration identifying additional schedules for at least one or more of the resources. After each schedule establishing iteration, it is determined if a pre-selected time limit has been exceeded, and whenever the time limit has been exceeded, the resource scheduler service 1212 ceases establishing schedules. The resource scheduler service 1212 then provides the schedules 1218 established for the resources to the field service provider associated with the resources and work orders. In one implementation, providing the schedules 1218 involves first selecting one of the schedules established for each resource as the schedule for the resource's shift. In this implementation, the selected one of the schedules established for each resource is provided to the field service provider associated with the resources and work orders.

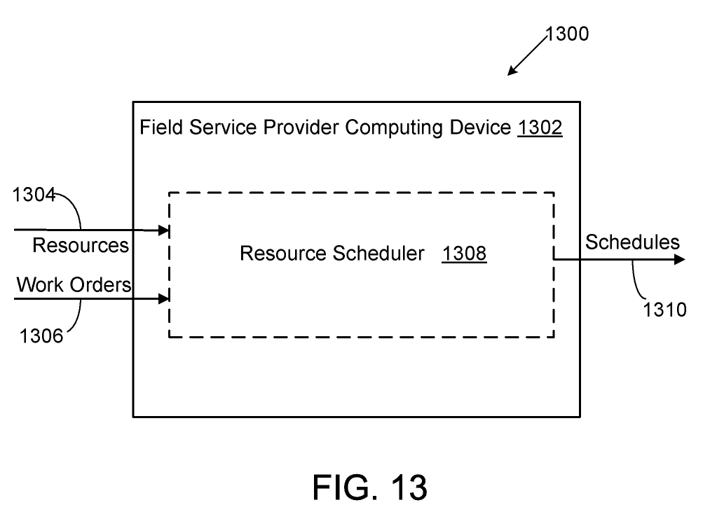

FIG. 13 illustrates another implementation, in simplified form, of a system framework for realizing the field service resource scheduling implementations described herein. As exemplified in FIG. 13, the system framework 1300 includes a field service provider computing device 1302 that is utilized by a field service provider. As before, the field service provider computing device 1302 can be any type of conventional mobile computing device such as a smartphone, or a tablet computer, or a laptop computer (sometimes also referred to as a notebook or netbook computer), or a computing device that is integrated into an automobile, among other types of conventional mobile computing devices. The field service provider computing device 1302 can also be any type of conventional non-mobile computing device such as a desktop personal computer (PC), among others.

Referring again to FIG. 13, field service provider computing device 1302 receives resource data 1304 and work order data 1306. The system framework 1300 also includes a resource scheduler computer program 1308 that runs on the computing device 1302, and which has a plurality of sub-programs executed by the computing device. As will also be described in more detail hereafter, this resource scheduler 1308 generally performs a variety of functions associated with scheduling resources to fulfill work orders for the field service provider. By way of example but not limitation, in an exemplary implementation of the resource scheduling described herein the resource scheduler 1308 identifies work orders associated with the field services from the received work order data 1304. Each of the identified work orders is assigned a physical location where the work order is to be fulfilled, a duration time indicating how long it will take to fulfill the work order, and a time window (or windows) indicating a period(s) of time in which the work order can be fulfilled. The resource scheduler 1308 also identifies, via the received resource data 1304, resources that are compatible with fulfilling one or more of the identified work orders during the course of a resource work shift. A resource is compatible with fulfilling a work order if the resource can travel to the work order location from a current location after a start time of the resource's work shift, arrive within the time window associated with the work order, fulfill the work order within the duration time associated with the work order, and still reach an end location by the end of the resource's work shift.

The resource scheduler 1308 then generates one or more schedules 1310 for each resource that, as described previously, details the work orders each resource is to fulfill, in what order and when, over the course of a resource's shift. More particularly, in one implementation, each schedule 1310 identifies a feasible sequence of one or more work orders that can be fulfilled by the resource over the course of the resource's work shift which reflect one or more prescribed scheduling objectives (as described previously). A sequence of one or more work orders is feasible if each work order in the sequence can be fulfilled by the resource taking into account the work orders' time windows, locations and duration times as well as the resource's anticipated starting location at a shift start time and the resource's anticipated end location at a shift end time, and further taking into account travel time between locations associated with the work order sequence. As with previously-described implementations, the schedules 1310 established for the resources are established in a series of iterations, with each iteration identifying additional schedules for at least one or more of the resources. After each schedule establishing iteration, it is determined if a pre-selected time limit has been exceeded, and whenever the time limit has been exceeded, the resource scheduler 1308 ceases establishing schedules. The resource scheduler 1308 then selects one of the schedules 1310 established for each resource as the schedule for the resource's shift. The selected one of the schedules 1310 is then provided to the field service provider associated with the resources and work orders.

### 6.1 Field Service Resource Scheduling System Overview

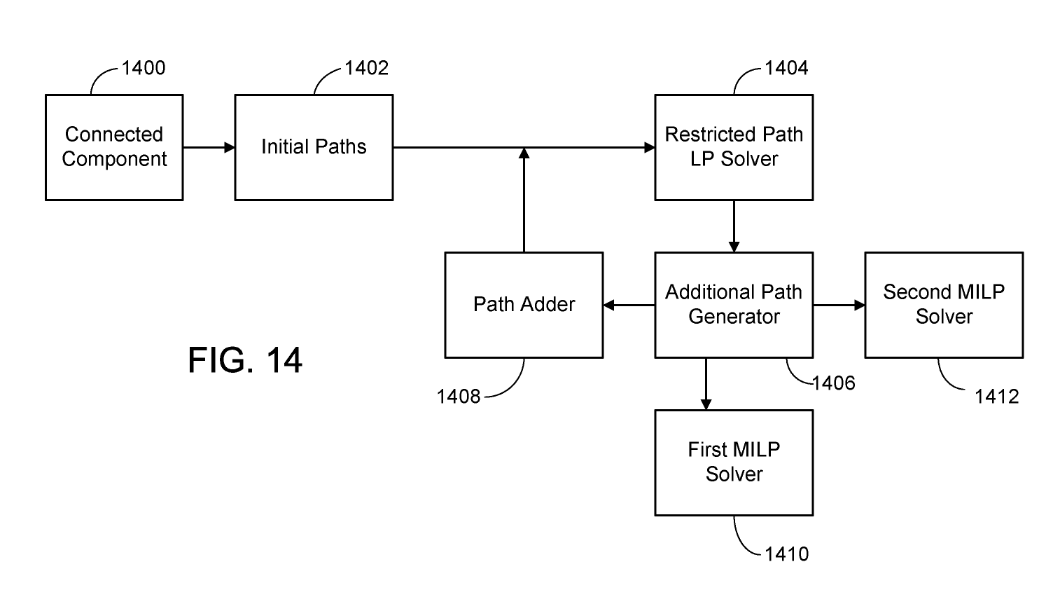

Referring to FIG. 14, an overview of the various constituents used by the previously-described resource scheduler service and resource scheduler to establish schedules is provided. As explained in section 3.6, if the eligibility graph consists of more than one connected component, the schedule generation problem is decomposed by considering each component independently. Each of the connected components that can be found in the work orders and resources associated with a field service provider is determined using the connected component constituent 1400. The work orders and resources associated with each identified connected component are then provided separately to an initial path constituent 1402, which generates the aforementioned set of initial paths. The set of initial paths are then provided to a commercially-available restricted path linear program (LP) solver constituent 1404. This constituent 1404 applies the aforementioned constraints to identify the previously-described resource and work order weights associated with the initial paths. Next, this information is passed to an additional path generator constituent 1406. The additional path generator constituent 1406 attempts to generate additional paths in one of the aforementioned additional path generation iterations in an allotted time. If additional paths are generated before the allotted time expires, then the additional paths are added to the previously generated paths (which may just be the initial paths) via the path adder constituent 1408 to produce a current set of paths. The current set of paths is then provided to the restricted path linear program solver constituent 1404, which applies the aforementioned constraints to identify resource and work order weights associated with the new set of paths. This information is passed to the additional path generator constituent 1406, and the process of attempting to generate additional paths in another one of the additional path generation iterations in the allotted time, adding any newly generated paths to the previous paths and providing the current set of paths to the restricted path linear program solver constituent 1404, is repeated until the allotted time runs out during one of the iterations, or no additional paths can be generated. If the allotted time runs out during one of the iterations, then the paths generated up to that time are provided to a first instance of a commercially-available mixed integer linear program (MILP) solver 1410. This first instance of the MILP solver 1410 generates schedules for each resource from the provided paths within an allotted time frame. If, however, the allotted time to generate paths does not run out before the additional path generator constituent 1406 is unable to generate any additional paths from the resources and work orders associated with the connected component under consideration, then the previously generated paths are provided to a second instance of a commercially-available MILP solver 1412. This second instance of the MILP solver 1412 generates schedules for each resource from the provided paths within an allotted time frame, or up to a prescribed percentage of an upper bound, or whichever occurs first.

With regard to the aforementioned prescribed percentage of the upper bound, another parameter that affects performance is a precision limit. As indicated above, there may be a time restriction on the generation of schedules which makes a non optimal solution in a reasonable time preferable. In view of this, it is also possible to impose a precision limit on the resource scheduling procedure. More particularly, a prescribed (or user-specified) precision limit can be imposed such that when the limit is met, the schedule generation ceases and just the schedules generated up to that point are provided—even if these schedules represent a less than optimal solution. For example, a precision limit of 5% (or 10%, or 20%, and so on) could be employed where the schedule generation would cease when the solution is 5% shy of the upper bound. It is noted that the upper bound is computed by the aforementioned LP solver.

### 6.2 Field Service Resource Scheduling System Details

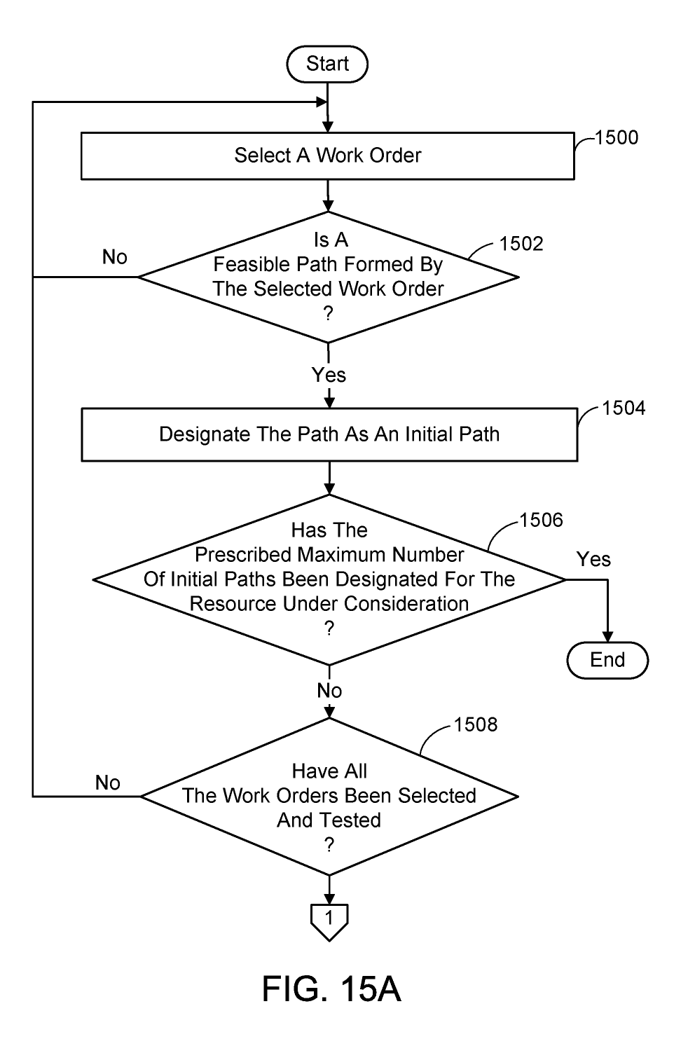

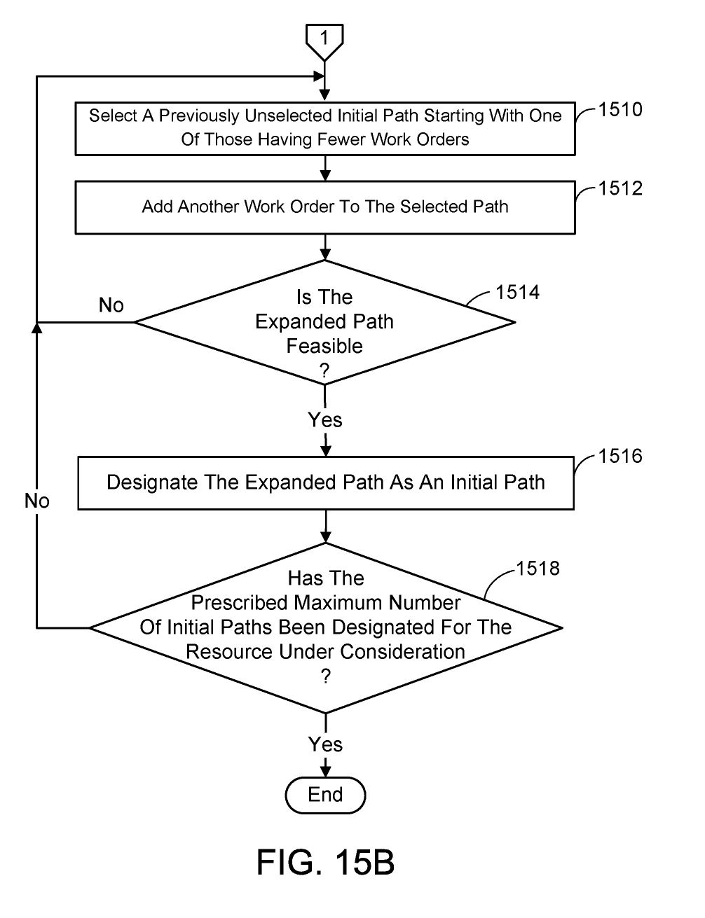

With regard to the aforementioned sub-program for establishing schedules for each resource, in one implementation the path-based solution described previously is employed to establish schedules for each identified resource. More particularly, one version of this path-based implementation, involves generating an initial set of paths up to a prescribed maximum number. More particularly, as illustrated in FIGS. 15A-B, a work order is selected (action 1500) and it is determined if a feasible path is formed by the selected work order (action 1502). A feasible path is one that represents the aforementioned feasible sequence of one or more work orders where a resource can leave a start location at a shift start time and travel to each work order, fulfill each work order within its duration time, and travel from the last work order in the sequence to an end location by a shift end time. If the path is not feasible, then actions 1500 and 1502 are repeated. When the path is found to be feasible, it is designated as one of the initial paths (action 1504), and it is determined if the aforementioned prescribed maximum number of initial paths have been designated for the resource under consideration (action 1506). If so, the process ends. If not, it is next determined if all the work orders have been selected and tested to determine whether it represents a feasible path (action 1508). If all the work orders have not been selected, then actions 1500 through 1508 are repeated. If all the work orders have been selected, then a previously unselected initial path is selected starting with one of those having fewer work orders (action 1510) and another work order is added to the path (action 1512). It is next determined if the expanded path is feasible (action 1514). If the expanded path is not feasible, then actions 1510 and 1512 are repeated. If the expanded path is feasible, it is designated as one of the initial paths (action 1516), and it is determined if the aforementioned prescribed maximum number of initial paths have been designated for the resource under consideration (action 1518). If so, the process ends. If not, actions 1510 through 1518 are repeated.

In one implementation, the path-based schedule generation can be ended with the first iteration and the initial paths can be used as the aforementioned schedules. However, as it could be advantageous to continue with subsequent iterations of the path-based solution to generate more optimal schedules, it will be assumed that additional iterations will be attempted (unless of course it is determined the previously-described pre-selected iteration time limit has been exceeded). These additional iterations will now be described in more detail.

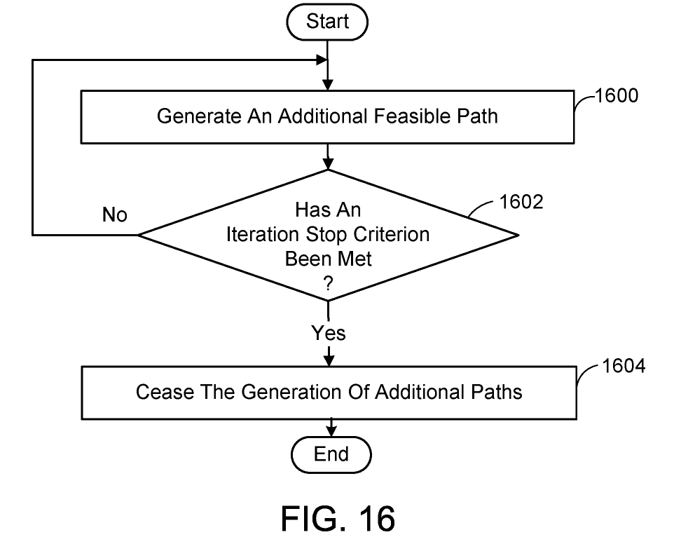

For each iteration associated with a resource, subsequent to the first iteration, as illustrated in FIG. 16, an additional feasible path is generated (action 1600). It is then determined if an iteration stop criterion has been met (action 1602). If not, actions 1600 and 1602 are repeated to produce more paths. However, if an iteration stop criterion has been met after the generation of an additional path, the generation of additional paths is ceased (action 1604). It is noted that whenever the generation of additional paths has ceased because an iteration stop criterion has been met, or the generation of additional paths has ceased because the aforementioned pre-selected time limit has been exceeded, establishing schedules from the paths involves generating schedules for each resource from the paths within an allotted time frame (consistent with the first instance of the MILP solver 1410 in FIG. 14). However, whenever no additional feasible paths can be generated prior to the pre-selected time limit being exceeded, establishing schedules from the paths involves generating schedules for each resource from the paths within an allotted time frame, or up to a prescribed percentage of an upper bound, or whichever occurs first (consistent with the second instance of the MILP solver 1412 in FIG. 14).

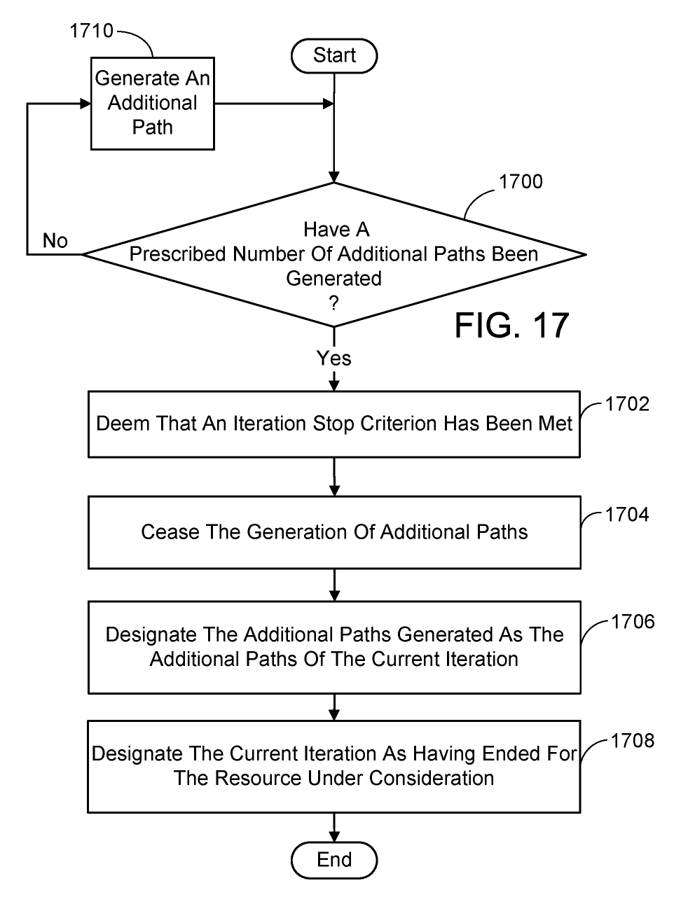

With regard to the sub-programs for determining if an iteration stop criterion has been met and ceasing the generation of additional paths whenever an iteration stop criterion has been met, after each additional path is generated, in one implementation which takes into consideration the number of additional paths generated, this takes the following form. As illustrated in FIG. 17, it is first determined whether a prescribed number of additional paths have been generated (action 1700). If so, it is deemed that an iteration stop criterion has been met (action 1702), and the generation of additional paths is ceased (action 1704). The additional paths generated in the current iteration are designated as the additional paths of the current iteration (action 1706), and the current iteration is designated as having ended for the resource under consideration (action 1708). If, however, it is determined that the prescribed number of additional paths have not been generated, an additional path is generated (action 1710), and action 1700 is repeated.

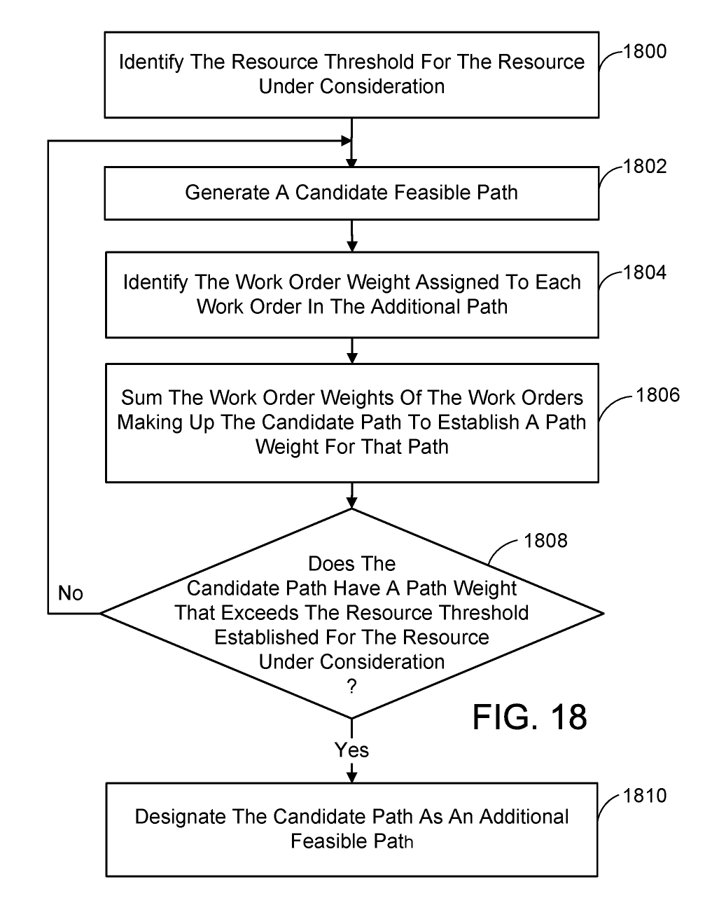

In other implementations, the aforementioned path weight and resource weight (or more accurately the resource threshold) is employed in the determination of whether an iteration is to be ended. More particularly, as illustrated in FIG. 18, a sub-program for generating an additional feasible path, includes in action 1800 identifying the resource threshold for the resource under consideration. Next, a candidate feasible path is generated (action 1802). The work order weight assigned to each work order in the candidate path is then identified (action 1804). The work order weights of the work orders making up the candidate path are summed to establish a path weight for that path (action 1806). It is next determined if the candidate path has a path weight that exceeds the resource threshold established for the resource under consideration (action 1808). If so, the candidate path is designated as an additional feasible path (action 1810) and the procedure ends. If, however, it is determined that the candidate path does not have a path weight that exceeds the resource threshold established for the resource under consideration, actions 1802 through 1808 are repeated as appropriate.

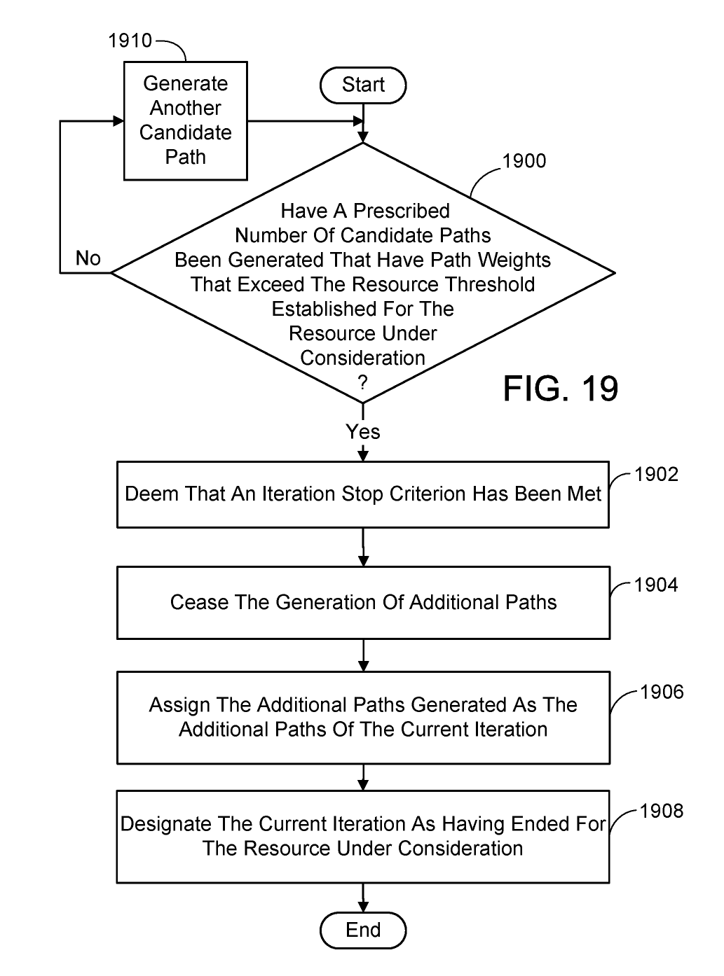

It is noted that in some circumstances the number of additional paths that can be generated in an iteration for a resource may be too extensive. In one implementation, this issue is resolved by limiting the number of candidate paths having path weights that exceed the resource threshold that can be generated. More particularly, referring now to FIG. 19, for each resource, after each additional candidate path is generated, it is determined whether a prescribed number of candidate paths have been generated that have path weights that exceed the resource threshold established for the resource under consideration (action 1900). If so, it is deemed that an iteration stop criterion has been met (1902), and the generation of candidate paths is ceased (action 1904). In addition, the additional paths generated in the current iteration are assigned to the current iteration (action 1906), and it is designated that the current iteration has ended for the resource under consideration (action 1908). If, however, it is determined that the prescribed number of candidate paths that have path weights that exceed the resource threshold established for the resource under consideration have not been generated, another candidate path is generated (action 1910) and action 1900 is repeated.

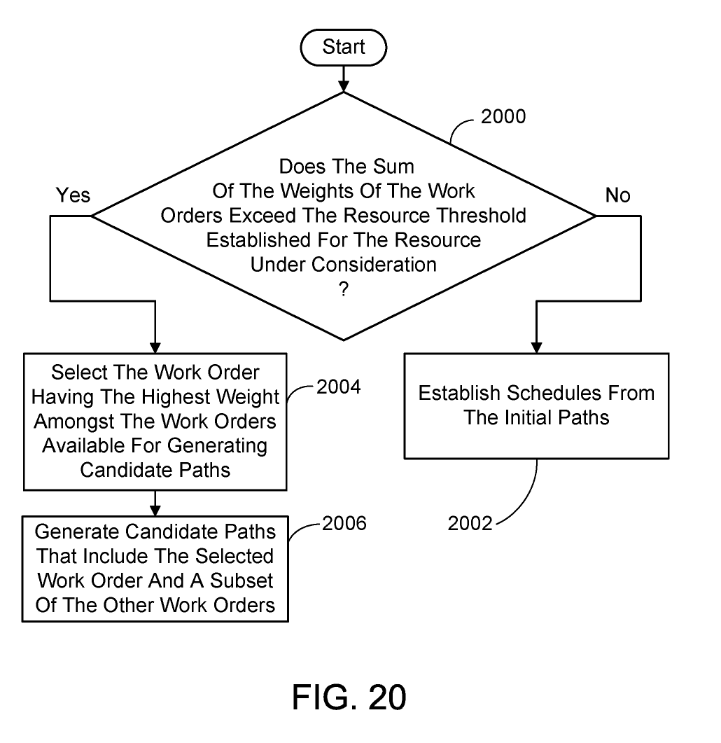

It is noted that there is a possibility that no candidate path will be found with a path weight that exceeds the resource threshold established for the resource under consideration. In such a case, the initial paths are deemed to be the final paths for the purposes of creating schedules for the resource. However, exhaustively searching for a candidate path with a path weight that exceeds the resource threshold may be too time consuming. Referring now to FIG. 20, in one implementation, this situation can be avoided by first determining whether the sum of the weights of the work orders exceed the resource threshold established for the resource under consideration (action 2000). If not, the aforementioned schedules are established from the initial paths (action 2002). If, however, it is determined that the sum of the weights of the work orders exceed the resource threshold established for the resource under consideration, select the work order having the highest weight amongst the work orders available for generating candidate paths (action 2004), and generate candidate paths that include the selected work order and a subset of the other work orders (action 2006).

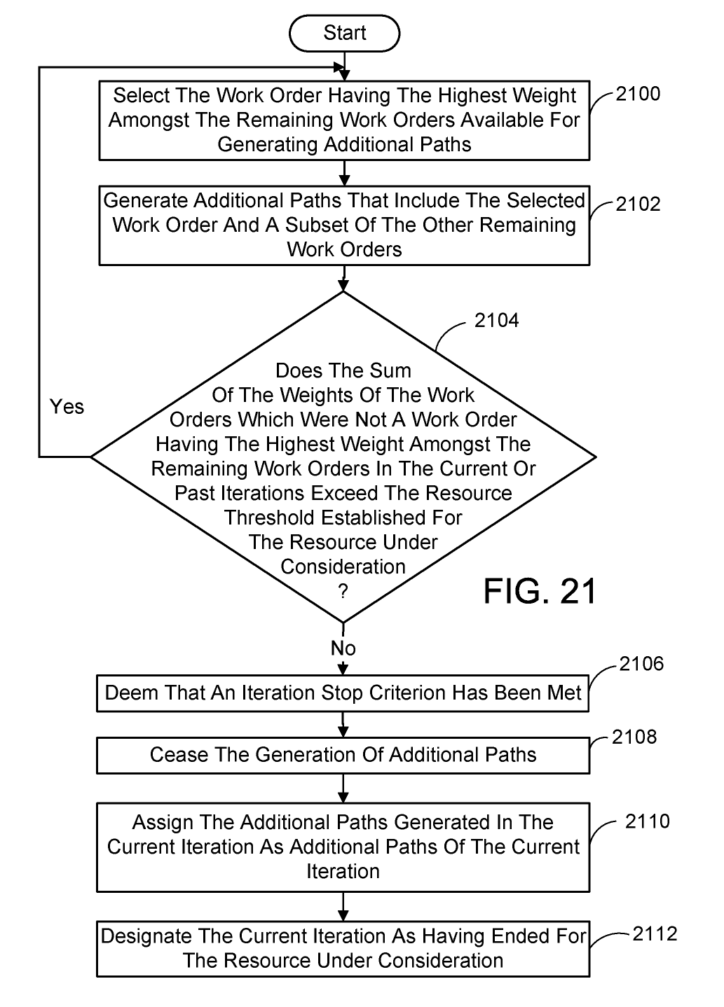

Referring now to FIG. 21, in one implementation, in each iteration, generating additional paths involves in action 2100 selecting the work order having the highest weight amongst the remaining work orders available for generating additional paths (unless one has already been selected in conjunction with checking the initial paths as described in FIG. 20), and generating additional paths that include the selected work order and a subset of the other remaining work orders (action 2102). It is then determined whether the sum of the weights of the work orders which were not a work order having the highest weight amongst the remaining work orders in the current or past iterations, exceed the resource threshold established for the resource under consideration (action 2104). If not, it is deemed that an iteration stop criterion has been met (2106), and the generation of additional paths is ceased (action 2108). The additional paths generated in the current iteration for the resource under consideration are assigned as the additional paths of the current iteration (action 2110), and it is deemed that the current iteration has ended for the resource under consideration (action 2112). If, however, it is determined that the sum of the weights does exceed the resource threshold established for the resource under consideration, actions 2100 through 2112 are repeated as appropriate.

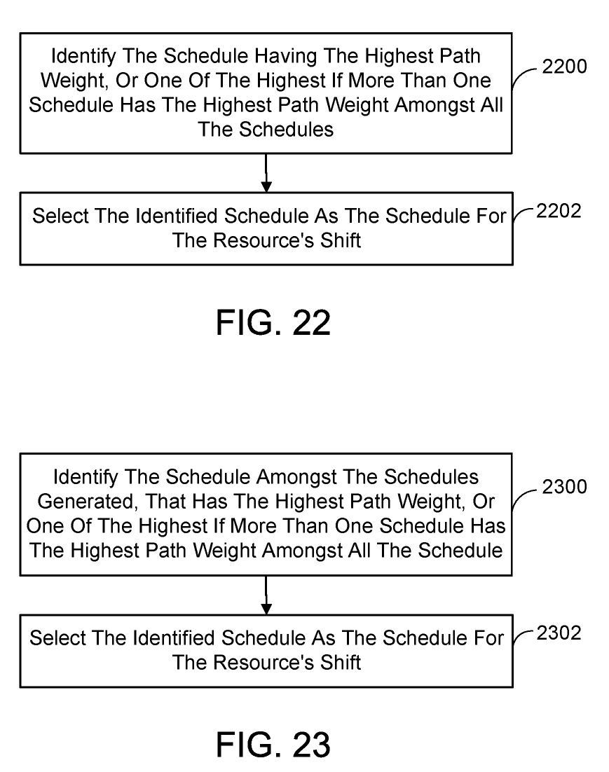

With regard to the aforementioned sub-program for selecting one of the schedules established for the resource as the schedule for the resource's shift, FIG. 22 illustrates one implementation, where this selecting involves identifying the schedule having the highest path weight, or one of the highest if more than one schedule has the highest path weight amongst all the schedules (action 2200). In action 2202, the identified schedule is selected as the schedule for the resource's shift. This implementation would be employed when the iteration procedure is stopped after the initial schedule is established in the first schedule establishing iteration.

In another implementation where the iteration procedure is stopped in a subsequent schedule establishing iteration, the sub-program for selecting one of the schedules established for the resource as the schedule for the resource's shift is accomplishes as follows. As illustrated in FIG. 23 the selection of a schedule for a resource involves identifying the schedule amongst the schedules generated, that has the highest path weight, or one of the highest if more than one schedule has the highest path weight amongst all the schedules (2300). In action 2302, the identified schedule is selected as the schedule for the resource's shift.

### 7.0 Field Service Resource Scheduling Process

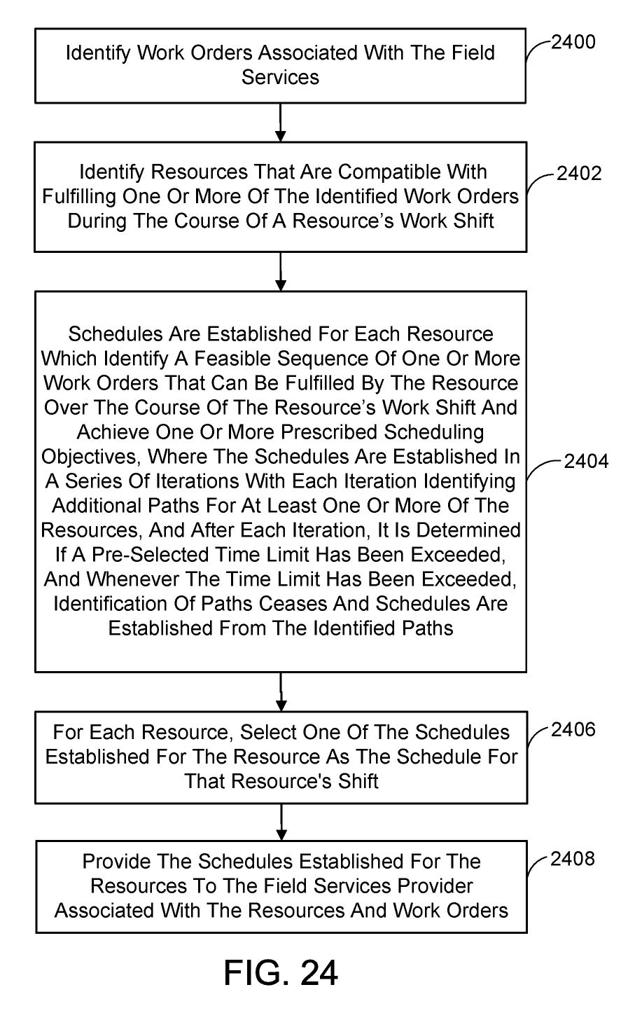

FIG. 24 illustrates an exemplary implementation, in simplified form, of a process for scheduling resources for field services. One implementation of the process illustrated in FIG. 24 is realized on the system framework 1200 illustrated in FIG. 12. Another implementation of the process illustrated in FIG. 24 is realized on the system framework 1300 illustrated in FIG. 13. As exemplified in FIG. 24, the process starts with identifying work orders associated with the field services (process action 2400). In this implementation each work order is assigned a physical location where the work order is to be fulfilled, a duration time indicating how long it will take to fulfill the work order, and a time window indicating a period of time in which the work order can be fulfilled. Resources that are compatible with fulfilling one or more work orders associated with the field services during the course of a resource's work shift are then identified (process action 2402). In this implementation, a resource is compatible with fulfilling a work order if the resource can travel to the work order location from a current location after a start time of the resource's work shift, arrive within the time window associated with the work order, fulfill the work order within the duration time associated with the work order, and still reach an end location by the end of the resources work shift. Next, schedules are established for each resource which identifies a feasible sequence of one or more work orders that can be fulfilled by the resource over the course of the resource's work shift and reflect one or more prescribed scheduling objectives. The schedules are established for the resources in a series of iterations with each iteration identifying paths for at least one or more of the resources. In addition, after each schedule establishing iteration, it is determined if a pre-selected time limit has been exceeded, and whenever the time limit has been exceeded, the identification of paths ceases and schedules are established from the identified paths. (process action 2404). A sequence of one or more work orders is feasible if each work order in the sequence can be fulfilled by the resource taking into account the work orders' time windows, locations and duration times as well as the resource's anticipated starting location at a shift start time and the resource's anticipated end location at a shift end time, and further taking into account travel time between locations associated with the work order sequence. Next, for each resource, one of the schedules established for the resource is selected as the schedule for the resource's shift (process action 2406). The schedules established for the resources are provided to the field service provider associated with the resources and work orders (process action 2408).

In one implementation, in order to be compatible with fulfilling work orders, a resource also has at least one of, a physical territory in which the locations of the work orders reside, or skills and/or characteristics needed to fulfill the work orders. Further, in one implementation, the degree to which the schedules generated for a resource reflect the one or more prescribed scheduling objectives increases with each schedule establishing iteration, and the pre-selected time limit is user specified such that whenever the user-specified time limit is reached, the current schedule establishing iteration is terminated, and all paths generated up to this termination are used to establish schedules for the resource under consideration even if the schedules do not fully achieve the one or more prescribed scheduling objectives.

Further, in one implementation, the one or more prescribed scheduling objectives include at least one of maximizing the number of work orders fulfilled; or maximizing the time in a resource's schedule spend fulfilling the work orders; or minimizing travel time between location in the resource's schedule; or maximize the priority of the work orders in the resource's schedule, where each work order is assigned a priority value; or maximizing the number of locked work order fulfilled, where a locked work order is a work order that is limited to a specific resource, or to being fulfilled at a specific time, or both. Whenever establishing schedules for a resource involves achieving more than one of the prescribed scheduling objectives, the schedules are established so as to reflect each of the multiple scheduling objectives in proportion to a weight that is assigned to that objective.

Still further, in one implementation, work orders in the selected schedule for the resource's shift which are already being fulfilled by another resource, are eliminated.

### 8.0 Other Implementations

While field service resource scheduling has been described by specific reference to implementations thereof, it is understood that variations and modifications thereof can be made without departing from the true spirit and scope thereof.

It is noted that any or all of the implementations that are described in the present document and any or all of the implementations that are illustrated in the accompanying drawings may be used and thus claimed in any combination desired to form additional hybrid implementations. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of the appended claims.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

### 9.0 Exemplary Operating Environments

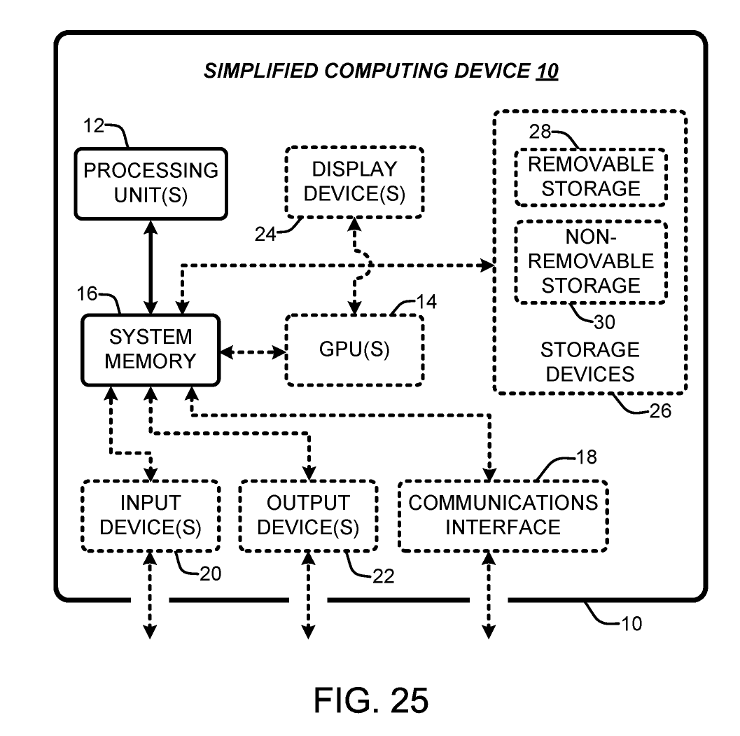

The resource scheduling implementations described herein are operational within numerous types of general purpose or special purpose computing system environments or configurations. FIG. 25 illustrates a simplified example of a general-purpose computer system on which various implementations and elements of resource scheduling, as described herein, may be implemented. It is noted that any boxes that are represented by broken or dashed lines in the simplified computing device 10 shown in FIG. 25 represent alternate implementations of the simplified computing device. As described below, any or all of these alternate implementations may be used in combination with other alternate implementations that are described throughout this document. The simplified computing device 10 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to realize the resource scheduling implementations described herein, the device should have a sufficient computational capability and system memory to enable basic computational operations. In particular, the computational capability of the simplified computing device 10 shown in FIG. 25 is generally illustrated by one or more processing unit(s) 12, and may also include one or more graphics processing units (GPUs) 14, either or both in communication with system memory 16. Note that that the processing unit(s) 12 of the simplified computing device 10 may be specialized microprocessors (such as a digital signal processor (DSP), a very long instruction word (VLIW) processor, a field-programmable gate array (FPGA), or other micro-controller) or can be conventional central processing units (CPUs) having one or more processing cores.

In addition, the simplified computing device 10 may also include other components, such as, for example, a communications interface 18. The simplified computing device 10 may also include one or more conventional computer input devices 20 (e.g., touchscreens, touch-sensitive surfaces, pointing devices, keyboards, audio input devices, voice or speech-based input and control devices, video input devices, haptic input devices, devices for receiving wired or wireless data transmissions such as the aforementioned the RF data signal receiver(s), and the like) or any combination of such devices.

Similarly, various interactions with the simplified computing device 10 and with any other component or feature of the resource scheduling implementations described herein, including input, output, control, feedback, and response to one or more users or other devices or systems associated with the resource scheduling implementations, are enabled by a variety of Natural User Interface (NUI) scenarios. The NUI techniques and scenarios enabled by the resource scheduling implementations include, but are not limited to, interface technologies that allow one or more users user to interact with the resource scheduling implementations in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other sensors (e.g., speech and/or voice recognition). Such NUI implementations are also enabled by the use of various techniques including, but not limited to, information derived from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices. Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the resource scheduling implementations described herein.

However, it should be understood that the aforementioned exemplary NUI scenarios may be further augmented by combining the use of artificial constraints or additional signals with any combination of NUI inputs. Such artificial constraints or additional signals may be imposed or generated by input devices such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the resource scheduling implementations described herein.

The simplified computing device 10 may also include other optional components such as one or more conventional computer output devices 22 (e.g., display device(s) 24, audio output devices, video output devices, devices for transmitting wired or wireless data transmissions, and the like). Note that typical communications interfaces 18, input devices 20, output devices 22, and storage devices 26 for general-purpose computers are well known to those skilled in the art, and will not be described in detail herein.

The simplified computing device 10 shown in FIG. 25 may also include a variety of computer-readable media. Computer-readable media can be any available media that can be accessed by the computer 10 via storage devices 26, and can include both volatile and nonvolatile media that is either removable 28 and/or non-removable 30, for storage of information such as computer-readable or computer-executable instructions, data structures, programs, sub-programs, or other data. Computer-readable media includes computer storage media and communication media. Computer storage media refers to tangible computer-readable or machine-readable media or storage devices such as digital versatile disks (DVDs), blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, programs, sub-programs, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, sub-programs, and/or computer program products embodying some or all of the various resource scheduling implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

The resource scheduling implementations described herein may be further described in the general context of computer-executable instructions, such as programs, sub-programs, being executed by a computing device. Generally, sub-programs include routines, programs, objects, components, data structures, and the like, that perform particular tasks or implement particular abstract data types. The resource scheduling implementations may also be practiced in distributed computing environments where tasks are performed by one or more remote processing devices, or within a cloud of one or more devices, that are linked through one or more communications networks. In a distributed computing environment, sub-programs may be located in both local and remote computer storage media including media storage devices. Additionally, the aforementioned instructions may be implemented, in part or in whole, as hardware logic circuits, which may or may not include a processor.

Alternatively, or in addition, the functionality described herein can be performed, at least in part, by one or more hardware logic components. For example, and without limitation, illustrative types of hardware logic components that can be used include FPGAs, application-specific integrated circuits (ASICs), application-specific standard products (ASSPs), system-on-a-chip systems (SOCs), complex programmable logic devices (CPLDs), and so on.

Wherefore, what is claimed is:

1. A system for scheduling resources for field services, comprising:
a resource scheduler comprising one or more computing devices, said computing devices being in communication with each other via a computer network whenever there is a plurality of computing devices, and a computer program having a plurality of sub-programs executed by said computing devices, wherein the sub-programs cause said computing devices to,
receive the identity of work orders associated with said field services, wherein each work order is assigned attributes identifying where and when the work order is to be fulfilled;
receive the identity of resources that are capable with fulfilling one or more of the work orders associated with said field services during the course of a resource work shift,
establish schedules for each resource which identify a sequence of one or more work orders that can be fulfilled by the resource over the course of the resource's work shift and reflect one or more prescribed scheduling objectives, wherein said schedules established for the resources are established in a series of iterations with each iteration identifying paths for at least one or more of the resources, and wherein after each iteration, determining if a pre-selected time limit has been exceeded, and whenever the time limit has been exceeded, ceasing identifying paths and establishing schedules from the identified paths, and
provide the schedules established for the resources to a field service provider associated with the resources and work orders.

2. The system of claim 1, wherein prior to executing the sub-program for providing the schedules established for the resources, a sub-program for selecting one of the schedules established for each resource as the schedule for the resource's shift is executed, such that the selected one of the schedules established for each resource is provided to the field service provider associated with the resources and work orders.

3. A system for scheduling resources for field services, comprising:
a field service provider computing device and a resource scheduler computer program having a plurality of sub-programs executed by said computing device, wherein the sub-programs cause said computing device to,
identify work orders associated with said field services, wherein each work order is assigned a physical location where the work order is to be fulfilled, a duration time indicating how long it will take to fulfill the work order, and a time window indicating a period of time in which the work order can be fulfilled;
identify resources that are compatible with fulfilling one or more of the identified work orders during the course of a resource work shift, wherein a resource is compatible with fulfilling a work order if the resource can travel to the work order location from a current location after a start time of the resource's work shift, arrive within the time window associated with the work order, fulfill the work order within the duration time associated with the work order, and still reach an end location by the end of the resource's work shift,
establish schedules for each resource which identify a feasible sequence of one or more work orders that can be fulfilled by the resource over the course of the resource's work shift and reflect one or more prescribed scheduling objectives, wherein a sequence of one or more work orders is feasible if each work order in the sequence can be fulfilled by the resource taking into account the work orders' time windows, locations and duration times as well as the resource's anticipated starting location at a shift start time and the resource's anticipated end location at a shift end time, and further taking into account travel time between locations associated with the work order sequence, and wherein said schedules established for the resources are established in a series of iterations with each iteration identifying paths for at least one or more of the resources, and wherein after each iteration, determining if a pre-selected time limit has been exceeded, and whenever the time limit has been exceeded, ceasing identifying paths and establishing schedules from the identified paths,
for each resource, select one of the schedules established for the resource as the schedule for the resource's shift.

4. The system of claim 3, wherein the sub-program for establishing schedules for each resource, comprises employing a path-based solution.

5. The system of claim 4, wherein the sub-program for establishing schedules for each resource, comprises sub-programs for:
generating an initial set of paths up to a prescribed maximum number of initial paths, wherein generating the initial set of paths comprises,
a) selecting a work order and determining if a feasible path is formed by the selected work order in that a feasible path represents said feasible sequence of one or more work orders wherein a resource can leave a start location at a shift start time and travel to each work order, fulfill each work order within its duration time, and travel from the last work order in the sequence to an end location by a shift end time,
b) if the path is feasible, designating it as an initial path,
c) determining if a prescribed maximum number of initial paths have been designated,
d) if the prescribed maximum number of initial paths has not been designated, selecting a previously unselected initial path starting with one of those having fewer work orders in the path,
e) adding another work order to the selected initial path to produce an expanded path,
f) determining if the expanded path is a feasible path,
g) if the expanded path is feasible, designating it as an initial path,
h) determining if the prescribed maximum number of initial paths have been designated, and
i) repeating d) though h) until the prescribed maximum number of initial paths have been designated.

6. The system of claim 5, further comprising sub-programs for:
for each resource,
identifying the resource threshold for the resource under consideration;
generating candidate feasible paths;
for each candidate path generated,
for each work order in the candidate path, identifying a work order weight that is assigned to that work order;
summing the work order weights to establish a path weight for the candidate path, and
determining whether the path weight for the additional path exceeds the resource threshold established for the resource,
whenever it is found that none of the generated candidate paths has a path weight that exceeds the resource threshold established for the resource under consideration, establishing the schedules from the initial paths

7. The system of claim 5, further comprising sub-programs for:
for each resource,
identifying the resource threshold for the resource under consideration,
identifying a work order weight that is assigned to each work order in the initial paths,
determining whether the sum of the weights of the work orders exceeds the resource threshold established for the resource under consideration,
whenever it is determined that the sum of the weights does not exceed the resource threshold established for the resource under consideration, establishing schedules from the initial paths, and
whenever it is determined that the sum of the weights does exceed the resource threshold established for the resource under consideration, selecting a work order having the highest weight amongst the identified work orders, and generating candidate paths that include the selected work order and a subset of the other work orders.

8. The system of claim 4, wherein the sub-program for establishing schedules for each resource, further comprises sub-programs for:
for each schedule establishing iteration subsequent to the first,
for each resource,
generating additional feasible paths;
after each additional path is generated, determining if an iteration stop criterion has been met; and
ceasing the generation of additional paths whenever an iteration stop criterion has been met.

9. The system of claim 8, wherein the sub-programs for, after each additional path is generated, determining if an iteration stop criterion has been met, and ceasing the generation of additional paths whenever an iteration stop criterion has been met, comprise:
determining whether a prescribed number of additional paths have been generated;
whenever it is determined that the prescribed number of additional paths have been generated,
deeming that an iteration stop criterion has been met,
ceasing the generation of additional paths,
assigning the additional paths generated in the current iteration as the additional paths of the current iteration, and
designating the current iteration has ended for the resource under consideration.

10. The system of claim 8, wherein the sub-program for generating additional feasible paths, comprises:
identifying the resource threshold for the resource under consideration;
generate candidate feasible paths;
for each candidate path generated,
for each work order in the candidate path, identifying a work order weight that is assigned to that work order;
summing the work order weights to establish a path weight for the candidate path, and
determining whether the path weight for the additional path exceeds the resource threshold established for the resource, and designating the candidate path as an additional feasible path if its path weight exceeds the threshold.

11. The system of claim 10, wherein the sub-programs for, after each additional path is generated, determining if an iteration stop criterion has been met, and ceasing the generation of additional paths whenever an iteration stop criterion has been met, comprise:
determining whether a prescribed number of candidate paths have been generated that have path weights that exceed the resource threshold established for the resource under consideration;
whenever it is determined that the prescribed number of candidate paths have been generated that have path weights that exceed the resource threshold established for the resource under consideration,
deeming that an iteration stop criterion has been met,
ceasing the generation of additional paths,
assigning the additional paths generated in the current iteration as the additional paths of the current iteration, and
designating the current iteration has ended for the resource under consideration.

12. The system of claim 10, wherein the sub-programs for determining if an iteration stop criterion has been met, and ceasing the generation of additional paths whenever an iteration stop criterion has been met, comprise:
selecting a work order having the highest weight amongst the remaining work orders available for generating additional paths;
generating additional paths that include the selected work order and a subset of the other remaining work orders;
determining whether the sum of the weights of the work orders which were not a work order having the highest weight amongst the remaining work orders in the current or past iterations, exceed the resource threshold established for the resource under consideration; and
whenever it is determined that the sum of the weights does not exceed the resource threshold established for the resource under consideration,
deeming that an iteration stop criterion has been met,
ceasing the generation of additional paths,
assigning the additional paths generated in the current iteration as the additional paths of the current iteration, and
designating the current iteration has ended for the resource under consideration.

13. The system of claim 8, wherein whenever the generation of additional paths has ceased because an iteration stop criterion has been met, or the generation of additional paths has ceased because the pre-selected time limit has been exceeded, establishing schedules from the paths comprises generating schedules for each resource from the paths within an allotted time frame.

14. The system of claim 8, further comprising, whenever no additional feasible paths can be generated prior to the pre-selected time limit being exceeded, establishing schedules from the paths comprises generating schedules for each resource from the paths within an allotted time frame, or up to a prescribed percentage of an upper bound, or whichever occurs first.

15. A computer-implemented process for scheduling resources for field services, comprising the actions of:
using one or more computing devices to perform the following process actions, the computing devices being in communication with each other via a computer network whenever a plurality of computing devices is used:
identifying work orders associated with said field services, wherein each work order is assigned a physical location where the work order is to be fulfilled, a duration time indicating how long it will take to fulfill the work order, and a time window indicating a period of time in which the work order can be fulfilled;
identifying resources that are compatible with fulfilling one or more of the identified work orders during the course of a resource work shift, wherein a resource is compatible with fulfilling a work order if the resource has skills or characteristics, or both, needed to fulfill the work orders, can travel to the work order location from a current location after a start time of the resource's work shift, arrive within the time window associated with the work order, fulfill the work order within the duration time associated with the work order, and still reach an end location by the end of the resource's work shift,
establishing schedules for each resource which identify a feasible sequence of one or more work orders that can be fulfilled by the resource over the course of the resource's work shift and reflect one or more prescribed scheduling objectives, wherein a sequence of one or more work orders is feasible if each work order in the sequence can be fulfilled by the resource taking into account the work orders' time windows, locations and duration times as well as the resource's anticipated starting location at a shift start time and the resource's anticipated end location at a shift end time, and further taking into account travel time between locations associated with the work order sequence, and wherein said schedules established for the resources are established in a series of iterations with each iteration identifying paths for at least one or more of the resources, and wherein after each iteration, determining if a pre-selected time limit has been exceeded, and whenever the time limit has been exceeded, ceasing identifying paths and establishing schedules from the identified paths,
for each resource, selecting one of the schedules established for the resource as the schedule for the resource's shift.

16. The process of claim 15, wherein in order to be compatible with fulfilling work orders, a resource also has to be assigned to a physical territory in which the locations of the work orders reside.

17. The process of claim 15, wherein the degree to which the schedules generated for a resource reflect the one or more prescribed scheduling objectives increases with each schedule establishing iteration, and wherein the pre-selected time limit is user specified such that whenever the user-specified time limit is reached, the current iteration is terminated, and the paths generated up to said termination are used to establish schedules for the resource under consideration even if the schedules do not fully achieve said one or more prescribed scheduling objectives.

18. The process of claim 15, wherein the one or more prescribed scheduling objectives comprises at least one of:
maximizing the number of work orders fulfilled; or
maximizing the time in a resource's schedule spend fulfilling the work orders; or
minimizing travel time between location in the resource's schedule; or
maximize the priority of the work orders in the resource's schedule, wherein each work order is assigned a priority value; or
maximizing the number of locked work order fulfilled, wherein a locked work order is a work order that is limited to a specific resource, or to being fulfilled at a specific time, or both.

19. The process of claim 15, wherein whenever establishing schedules for a resource involves reflecting more than one of the prescribed scheduling objectives, the schedules are established so as to reflect each of the multiple scheduling objectives in proportion to a weight that is assigned to that objective.

20. The process of claim 15, further comprising a process action of eliminating work orders in the selected schedule for the resource's shift which are already being fulfilled by another resource.
